(19) United States
(12) Patent Application Publication
(10) Pub. No.: US 2009/0048120 A1
(43) Pub. Date: Feb. 19, 2009

(54) ATOMIC FORCE MICROSCOPE AS AN ANALYZING TOOL FOR BIOCHIP

(76) Inventors: Joon Won Park, Pohang (KR); Bong Jin Hong, Pohang (KR); Sung Hong Kwon, Pohang (KR)

Correspondence Address: JHK LAW, P.O. BOX 1078, LA CANADA, CA, 91012-1078, US

(21) Appl. No.: 12/140,226

(22) Filed: Jun. 16, 2008

Related U.S. Application Data
(60) Provisional application No. 60/944,056, filed on Jun. 14, 2007.

(51) Int. Cl. C40B 30/10; C40B 60/12

(52) U.S. Cl. 506/9; 506/39

(57) ABSTRACT

The present application discloses a method for detecting a presence of target ligand in a fluid medium which includes the steps of: (i) contacting the fluid medium with a solid substrate that includes an array of dendrons on its surface, wherein each of the dendron includes a central atom, a probe that is attached to the central atom optionally through a linker, and a base portion attached to the central atom and having a plurality of termini that are attached to the surface of the solid support; and (ii) determining the presence of a probe-target ligand complex by measuring binding force between the bound ligand and detection molecule tethered to the tip of an atomic force microscope (“AFM”), which detection molecule has affinity for the ligand, wherein measurement of an increase in force between the probe-target ligand complex and the detection molecule by AFM indicates the presence of the probe-target ligand complex.

### CROSS-REFERENCE TO RELATED APPLICATIONS

The present application claims priority to U.S. Provisional Patent Application No. 60/944,056, filed Jun. 14, 2007, the contents of which are incorporated by reference herein in their entirety.

### BACKGROUND OF THE INVENTION

1. Field of the Invention

The present invention relates generally to atomic force microscopy (AFM), and an apparatus and a measuring method of intermolecular interaction between the biomolecules using the same on a chip. The present invention regards the usage of dendron coated Bio-AFM tips in measuring the interaction force between biomolecules on a chip.

2. General Background and State of the Art

Recent advances in bioanalytical sciences and bioengineering have led to the development of DNA chips^{1,2}, miniaturized biosensors^{3,4}, and micro fluidic devices (e.g., microelectromechanical systems or bioMEMS)⁵⁻⁷. In particular, DNA microarray technology is an increasingly important tool since it considerably accelerates genetic analysis. It has been used for monitoring of gene expression, mutation detection, single nucleotide polymorphism analysis, and many other applications.⁸ However, conventional microarrays have limitations in flexibility, speed, cost, and sensitivity. In addition, most biochemical assays require secondary detection of a label, because biomolecules lack intrinsic properties that are useful for direct high-sensitivity detection. The most commonly used labels in biological diagnostics are organic fluorescent dyes. But organic dyes still suffer from limitations such as photobleaching and discrete excitation bands that preclude their use in many applications.⁹

An increasing number of studies have demonstrated the ability of ultrasensitive force measurement methods to study the unbinding kinetics of single molecular receptor/ligand pairs and to probe the mechanical properties of single biopolymeric molecules.¹⁰⁻¹³ Such studies have provided much insight into the role of force in a range of biological processes, including in cell adhesion, in protein unfolding, and on the dissociation of DNA/RNA oligonucleotide duplexes.¹⁴⁻¹⁶ However, many of these developments are currently hindered by the available biomolecule surface attachment methods, in that it is still not trivial to create surfaces and devices with highly defined surface functionality and/or uniformity. We reported a new approach to address such issues based on the formation of dendron arrays. Through the measurement of forces between dendron surfaces functionalized with complementary DNA oligonucleotides, we observed several unique properties of the surfaces modified via this approach.¹⁷

Dendrons, conically shaped molecules of which repeating units are directionally stretched from a core, are highly branched polymers with uniform size and molecular weight as well as well-defined structure. Because it is possible to control their size precisely and utilize their reactive termini for their effective self-assembly on the surface, they are considered as ideal building blocks for creating new materials of which the surface characteristics are finely tuned at the molecular level.¹⁸ The mesospacing provided by the cone shape was found to significantly improve efficacy of a DNA microarray, where each surface-immobilized capture probe DNA was provided with ample space for binding with incoming target DNAs, resulting in enhanced kinetics and selectivity similar to that observed in solution (100:1). Moreover, the observed high hybridization yield demonstrates that DNA probes with enough spacing between neighboring ones experienced minimal steric hindrance by neighboring probes or targets during the hybridization.

In the present application, Applicant describes an inventive approach using a force-based atomic force microscope which can study genotyping and gene expression, which is simple and label-free with high sensitivity. In this work, we examined genotyping and gene expression profiling by measuring the force between target DNAs hybridized with probe DNAs on the dendron-modified surface and detection DNAs on the AFM-tip through a force-based AFM. Through this detection method combined with the dendron-modified surface and AFM tip its sensitivity was superior to that of a conventional DNA microarray requiring a fluorescent labeling method.

### SUMMARY OF THE INVENTION

In one aspect the invention is directed to a force based atomic force microscope as an analyzing tool for genotyping and gene expression profiling without labeling process. The invention also relates to a nanoscale-engineered dendron surface to immobilize DNA, which provides good measurable force related to hybridization/binding events. The inventive method exhibits a sensitivity of ≦10³ target DNAs detectable without labeling, a level that is better than the 10⁵ number achievable with a high-density microarray system, and approaching the 10³-10⁴ level usually observed for quantitative PCR (qPCR) for genotyping study. The sensitivity of Bio AFM measurement was increased 10⁵ times over conventional microarray for gene expression profiling. Lateral spacing of dendron modified surface can scale in a highly predictable manner. Force based AFM is readily adaptable to other bio-chip systems.

In another aspect, the invention is directed to a method for detecting a presence of target ligand in a fluid medium comprising: (i) contacting the fluid medium with a solid substrate, wherein the solid substrate comprises: array of dendrons on its surface, wherein each of the dendron comprises: a central atom; a probe that is attached to the central atom optionally through a linker; and a base portion attached to the central atom and having a plurality of termini that are attached to the surface of the solid support; and (ii) determining the presence of a probe-target ligand complex by measuring binding force between the bound ligand and detection molecule that has affinity for the ligand, wherein the detection molecule is tethered to surface of a tip of an atomic force microscope (“AFM”), wherein measurement of an increase in force between the probe-target ligand complex and the detection molecule indicates the presence of the probe-target ligand complex.

In a preferred embodiment, the probe-target ligand complex is an oligonucleotide-complementary nucleic acid complex. The probe-target ligand complex may be detected in the presence of low concentration of the target ligand, which is at a concentration of at least about 1 aM, or between about 1 aM to about 1000 aM. The above method is capable of discriminating a single nucleotide polymorphism in the oligonucleotide-complementary nucleic acid complex.

The detection molecule may be a detection nucleic acid. The detection molecule may be comprised of a poly-dT oligomer sufficiently complementary to a poly-dA section of RNA. The solid substrate may be a non-porous solid support. It may be planar non-porous solid support, or planar non-porous solid support, such as but not limited to silica. The tip of the atomic force microscope (“AFM”) may be coated with dendron. In another embodiment, the target ligand may not be labeled. The method may further include cross-linking the probe-ligand complex. Or, the probe-ligand complex may be covalently linked to an affinity molecule, and detection molecule specifically binds to the affinity molecule. The affinity molecule may be an antigen or an antibody. The detection molecule may be a protein that selectively binds to double stranded DNA. Or, the probe-ligand complex may form a triple helix formation with the detection molecule. The detection molecule may be a DNA intercalating agent. The detection molecule may be also a protein, which selectively binds to a mismatched section of a double stranded DNA. And, the array may be displayed on a chip.

The present invention is also directed to a system for detection of target nucleic acid, comprising, (i) a chip immobilized with probe molecules, and (ii) an atomic force microscope (“AFM”) comprising a tip on which is tethered detection molecule. The chip may coated with dendrons on which are tethered probe molecules. Also, the tip of the AFM may be also coated with dendrons, on which are immobilized detection molecule.

These and other objects of the invention will be more fully understood from the following description of the invention, the referenced drawings attached hereto and the claims appended hereto.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIGS. 1a-1b show (a) Schematic of the experimental setup employed for the measurement described within this study. After target DNAs were hybridized with probe DNAs immobilized on the dendron-modified surfaces, force measurements were recorded by bringing the AFM tip to tethering detection DNA and substrate into and out of contact. (b) A typical measurement (inset: retract traces (blue curves)) and distribution of adhesive forces recorded for the complementary 15-mer sequence.

FIGS. 2a-2c show (a) The structure of a mature eukaryotic mRNA. A fully processed mRNA includes a 5′ cap, 5′ UTR, coding region, 3′ UTR, and poly(A) tail. (b) The fluorescence image of DNA microarray experiments after hybridization between the 64 probe DNAs immobilized on dendron surface and cDNA prepared from universal human reference total RNA (UHRR). White arrow indicates probe no. 62 DNA. (c) Force mapping image after hybridization with 0.62 fg/μl UHRR.

FIGS. 3a-3b show DNA chip assays. (a) DNA chip assay using fluorescent labels. (b) DNA chip assay using a Bio-AFM.

FIGS. 4a-4b show DNA chip assay using fluorescent labels. (a) 1 pM target DNA. (b) 100 fM target DNA.

FIGS. 5a-5d show force map between the target and detection DNA using a Bio-AFM. (a) 1 pM target DNA. (b) 10 fM target DNA. (c) 100 aM target DNA. (d) 1 aM target DNA.

FIG. 6 shows force-distance measurements between the target and detection DNA.

FIG. 7 shows linear relationship between the target DNA concentration and detection sensitivity.

FIG. 8 shows force map between the non-complementary target and detection DNA using Bio-AFM.

FIG. 9 shows DNA chip assay of crosslinking probe and target DNA.

FIG. 10 shows DNA chip assay of the streptavidin-biotin bond.

FIG. 11 shows DNA chip assay of antigen-antibody bond.

FIG. 12 shows DNA chip assay of protein-DNA bond.

FIG. 13 shows DNA chip assay of triplex DNA formation.

FIG. 14 shows DNA chip assay of intercalated DNA.

FIG. 15 shows DNA chip assay of single-base mutation using MutS protein.

FIG. 16 shows DNA chip assay on Dendron surface using force measurement between DNA.

FIG. 17 shows gene expression determination using Bio-AFM.

### DETAILED DESCRIPTION OF THE PREFERRED EMBODIMENTS

In the present application, “a” and “an” are used to refer to both single and a plurality of objects.

As used herein, “aptamer” means a single-stranded, partially single-stranded, partially double-stranded or double-stranded nucleotide sequence, advantageously replicable nucleotide sequence, capable of specifically recognizing a selected nonoligonucleotide molecule or group of molecules by a mechanism other than Watson-Crick base pairing or triplex formation.

As used herein, “affinity molecule” refers to a molecule that is attached to a probe/target ligand complex. The affinity molecule may be bound to the probe, target ligand or both, which is later detected by the detection molecule in order to detect the presence of the probe/target ligand complex. The affinity molecule may be any type of biomolecule. An example of such an affinity molecule is an antigen, which is bound to the complex, which is detected by a detection antibody affixed on the surface of the tip of an atomic force microscope. Another example includes probe/target ligand complex coupled to streptavidin. “Detection biotin” tethered to the surface of the tip of an atomic force microscope is used to detect the presence of streptavidin, which indirectly indicates the presence of the probe/ligand complex.

As used herein, “array” and “library” are used interchangeably herein and refer to a random or nonrandom mixture, collection or assortment of molecules, materials, surfaces, structural shapes, surface features or, optionally and without limitation, various chemical entities, monomers, polymers, structures, precursors, products, modifications, derivatives, substances, conformations, shapes, or features. “Array” or “array of regions on a solid support” refers to a linear or two-dimensional array of preferably discrete regions, each having a finite area, formed on the surface of a solid support.

As used herein, “arrayed library” refers to individual probe molecules that are placed in two-dimensional arrays in microtiter (multiwell) dishes or plates on a solid substrate. The identity of the plate and the clone location (row and column) on that plate are marked. Arrayed libraries of clones can be used for many applications, including screening for a specific gene or genomic region of interest as well as for physical mapping, genotyping, SNP identification, gene expression profiling and so on.

As used herein, “bifunctional,” “trifunctional” and “multifunctional,” when used in reference to a synthetic polymer or multivalent homo- or heteropolymeric hybrid structure, mean bivalent, trivalent or multivalent, as the case may be, or comprising two, three or multiple specific recognition elements, defined sequence segments or attachment sites.

As used herein, “biochip” or “chip” is a collection of miniaturized test sites (microarrays or nanoarrays) arranged on a solid substrate that permits many tests to be performed at the same time in order to achieve higher throughput and speed. Biochip is used to pack traditionally bulky sensing tools into smaller and smaller spaces. These chips are essentially miniaturized laboratories that can perform hundreds or thousands of simultaneous biochemical reactions. Biochips enable researchers to quickly screen large numbers of biological analytes for a variety of purposes, from disease diagnosis to detection of bioterrorism agents. The actual sensing component (or “chip”) is just one piece of a complete analysis system. Transduction must be done to translate the actual sensing event (DNA binding, oxidation/reduction, and so forth.) into a format understandable by a computer (measurement of force, voltage, light intensity, mass and so forth), which then enables additional analysis and processing to produce a final, human-readable output. The chips are typically produced using microlithography techniques traditionally used to fabricate integrated circuits.

As used herein, “biomimetic” means a molecule, group, multimolecular structure or method that mimics a biological molecule, group of molecules, structure.

As used herein, “cDNA library” used with respect to a probe library immobilized on a substrate refers to a library composed of probe molecules, which may be specific to target ligands.

As used herein, “dendritic molecule” is a molecule exhibiting regular dendritic branching, formed by the sequential or generational addition of branched layers to or from a core.

The term “dendron” refers to a polymer exhibiting regular dendritic branching, formed by the sequential or generational addition of branched layers to or from a core. The term dendritic polymer encompasses “dendrimers”, which are characterized by a core, at least one interior branched layer, and a surface branched layer (see, e.g., Petar et al. Pages 641-645 In Chem. in Britain, (August 1994). A “dendron” is a species of dendrimer having branches emanating from a focal point or a central atom, which is or can be joined to a core, either directly or through a linking moiety to form a dendrimer. Many dendrimers comprise two or more dendrons joined to a common core.

Dendrons include, but are not limited to, symmetrical and asymmetrical branching dendrimers, cascade molecules, arborols, and the like. In some embodiments, the branch arms are of equal length. However, it is also contemplated that asymmetric dendrimers may also be used.

Further, it is understood that even though not formed by regular sequential addition of branched layers, hyperbranched polymers, e.g., hyperbranched polyols, may be equivalent to a dendritic polymer where the branching pattern exhibits a degree of regularity approaching that of a dendrimer.

As used herein, “detection molecule” such as “detection DNA”, “detection ligand”, “detection oligomer”, refer to the molecule that is attached to the tip of AFM used to determine force of binding in a probe/target complex.

As used herein, “hyperbranched” or “branched” as it is used to describe a macromolecule or a dendron structure is meant to refer to a plurality of polymers having a plurality of termini which are able to bind covalently or ionically to a substrate. In one embodiment, the macromolecule comprising the branched or hyperbranched structure is “pre-made” and is then attached to a substrate. Accordingly, the inventive macromolecule excludes polymer cross-linking methods as disclosed in U.S. Pat. No. 5,624,711 (Sundberg et al.).

As used herein, “immobilized” means insolubilized or comprising, attached to or operatively associated with an insoluble, partially insoluble, colloidal, particulate, dispersed, suspended and/or dehydrated substance or a molecule or solid phase comprising or attached to a solid support.

As used herein, “linker molecule,” and “linker” when used in reference to a molecule that joins the branched portion of a size-controlled macromolecule such as a branched/linear polymer to a protecting group or a ligand. Linkers may include, for instance and without limitation, spacer molecules, for instance selected molecules capable of attaching a ligand to a dendron.

As used herein, “low concentration” of target ligand that is required for the target ligand to be detectable is used herein to indicate the powerful sensitivity of the inventive target ligand detection method. Such lower limit of concentration of the detectable amount of the target ligand may include from 1 to 10000 aM concentration, from 1 to 1000 aM, from 1 to 100 aM, or from 1 to 10 aM.

As used herein, “low density” refers to about 0.005 to about 0.5 probe/nm², preferably about 0.01 to about 0.2, more preferably about 0.01 to about 0.1, and most preferably about 0.05 probe/nm²

As used herein, a “microarray” refers to an array of regions having a density of discrete regions of at least about 100/cm², and preferably at least about 1000/cm². The regions in a microarray have typical dimensions, e.g., diameters, in the range of between about 10-250 μm, and may be separated from other regions in the array by about the same distance. The microarray may comprises a selected set of probe molecules, which can be employed to examine expression of transcription or a profile of the expressed genes in a set of cells or detection of mutations in a gene.

As used herein, a “nanoarray” refers to an array of regions having a density of discrete regions of at least about 1000/mm², and preferably at least about 100000/mm². The regions in a nanoarray have typical dimensions, e.g., diameters, in the range of between about 10-1000 nm, and may be separated from other regions in the array by about the same distance. The nanoarray may comprises a selected set of probe molecules, which can be employed to examine expression of transcription or a profile of the expressed genes in a set of cells or detection of mutations in a gene.

As used herein, “molecular mimics” and “mimetics” are natural or synthetic nucleotide or normucleotide molecules or groups of molecules designed, selected, manufactured, modified or engineered to have a structure or function equivalent or similar to the structure or function of another molecule or group of molecules, e.g., a naturally occurring, biological or selectable molecule. Molecular mimics include molecules and multimolecular structures capable of functioning as replacements, alternatives, upgrades, improvements, structural analogs or functional analogs to natural, synthetic, selectable or biological molecules.

As used herein, “nucleotide analog” refers to molecules that can be used in place of naturally occurring bases in nucleic acid synthesis and processing, preferably enzymatic as well as chemical synthesis and processing, particularly modified nucleotides capable of base pairing and optionally synthetic bases that do not comprise adenine, guanine, cytosine, thymidine, uracil or minor bases. This term includes, but is not limited to, modified purines and pyrimidines, minor bases, convertible nucleosides, structural analogs of purines and pyrimidines, labeled, derivatized and modified nucleosides and nucleotides, conjugated nucleosides and nucleotides, sequence modifiers, terminus modifiers, spacer modifiers, and nucleotides with backbone modifications, including, but not limited to, ribose-modified nucleotides, phosphoramidates, phosphorothioates, phosphonamidites, methyl phosphonates, methyl phosphoramidites, methyl phosphonamidites, 5′-β-cyanoethyl phosphoramidites, methylenephosphonates, phosphorodithioates, peptide nucleic acids, achiral and neutral internucleotidic linkages and normucleotide bridges such as polyethylene glycol, aromatic polyamides and lipids.

As used herein, “polymer” or “branched/linear polymer” refers to a molecule having a branched structure at one end of the molecule and a linear portion at the other end so that the branched portion binds to a substrate and the linear portion binds to a ligand, probe or a protecting group.

As used herein, “polypeptide”, “peptide” and “protein” are used interchangeably herein to refer to a polymer of amino acid residues. The terms apply to amino acid polymers in which one or more amino acid residue is an artificial chemical analogue of a corresponding naturally occurring amino acid, as well as to naturally occurring amino acid polymers. The term may also include variants on the traditional peptide linkage joining the amino acids making up the polypeptide.

As used herein, “protecting group” refers to a group that is joined to a reactive group (e.g., a hydroxyl or an amine) on a molecule. The protecting group is chosen to prevent reaction of the particular radical during one or more steps of a chemical reaction. Generally the particular protecting group is chosen so as to permit removal at a later time to restore the reactive group without altering other reactive groups present in the molecule. The choice of a protecting group is a function of the particular radical to be protected and the compounds to which it will be exposed. The selection of protecting groups is well known to those of skill in the art. See, for example Greene et al., Protective Groups in Organic Synthesis, 2nd ed., John Wiley & Sons, Inc. Somerset, N.J. (1991), which is incorporated by reference herein in its entirety.

As used herein, “protected amine” refers to an amine that has been reacted with an amino protecting group. An amino protecting group prevents reaction of the amide function during attachment of the branched termini to a solid support in the situation where the linear tip functional group is an amino group. The amino protecting group can be removed at a later time to restore the amino group without altering other reactive groups present in the molecule. For example, the exocyclic amine may be reacted with dimethylformamide diethylacetal to form the dimethylaminomethylenamino function. Amino protecting groups generally include carbamates, benzyl radicals, imidates, and others known to those of skill in the art. Preferred amino protecting groups include, but are not limited to, p-nitrophenylethoxycarbonyl or dimethyaminomethylenamino.

As used herein, “regular intervals” refers to the spacing between the tips of the size-controlled macromolecules, which is a distance from about 1 nm to about 100 nm so as to allow room for interaction between the target-specific ligand and the target substantially without steric hindrance. Thus, the layer of macromolecules on a substrate is not too dense so that specific molecular interactions may occur.

As used herein, “solid support” refers to a composition comprising an immobilization matrix such as but not limited to, insolubilized substance, solid phase, surface, substrate, layer, coating, woven or nonwoven fiber, matrix, crystal, membrane, insoluble polymer, plastic, glass, biological or biocompatible or bioerodible or biodegradable polymer or matrix, microparticle or nanoparticle. Solid supports include, for example and without limitation, monolayers, bilayers, commercial membranes, resins, matrices, fibers, separation media, chromatography supports, polymers, plastics, glass, mica, gold, beads, microspheres, nanospheres, silicon, gallium arsenide, organic and inorganic metals, semiconductors, insulators, microstructures and nanostructures. Microstructures and nanostructures may include, without limitation, microminiaturized, nanometer-scale and supramolecular probes, tips, bars, pegs, plugs, rods, sleeves, wires, filaments, and tubes.

As used herein, “specific binding” refers to a measurable and reproducible degree of attraction between a ligand and its specific binding partner or between a defined sequence segment and a selected molecule or selected nucleic acid sequence. The degree of attraction need not be maximized to be optimal. Weak, moderate or strong attractions may be appropriate for different applications. The specific binding which occurs in these interactions is well known to those skilled in the art. When used in reference to synthetic defined sequence segments, synthetic aptamers, synthetic heteropolymers, nucleotide ligands, nucleotide receptors, shape recognition elements, and specifically attractive surfaces. The term “specific binding” may include specific recognition of structural shapes and surface features. Otherwise, specific binding refers explicitly to the specific, saturable, noncovalent interaction between two molecules (i.e., specific binding partners) that can be competitively inhibited by a third molecule (i.e., competitor) sharing a chemical identity (i.e., one or more identical chemical groups) or molecular recognition property (i.e., molecular binding specificity) with either specific binding partner. The competitor may be, e.g., a cross-reactant, or analog of an antibody or its antigen, a ligand or its receptor, or an aptamer or its target. Specific binding between an antibody and its antigen, for example, can be competitively inhibited either by a cross-reacting antibody or by a cross-reacting antigen. The term “specific binding” may be used for convenience to approximate or abbreviate a subset of specific recognition that includes both specific binding and structural shape recognition.

As used herein, “substrate,” when used in reference to a substance, structure, surface or material, means a composition comprising a nonbiological, synthetic, nonliving, planar, spherical or flat surface that is not heretofore known to comprise a specific binding, hybridization or catalytic recognition site or a plurality of different recognition sites or a number of different recognition sites which exceeds the number of different molecular species comprising the surface, structure or material. The substrate may include, for example and without limitation, semiconductors, synthetic (organic) metals, synthetic semiconductors, insulators and dopants; metals, alloys, elements, compounds and minerals; synthetic, cleaved, etched, lithographed, printed, machined and microfabricated slides, devices, structures and surfaces; industrial polymers, plastics, membranes; silicon, silicates, glass, metals and ceramics; wood, paper, cardboard, cotton, wool, cloth, woven and nonwoven fibers, materials and fabrics; nanostructures and microstructures unmodified by immobilization probe molecules through a branched/linear polymer.

As used herein, “target” or “targeting” in the context of an array system refers to the free nucleic acid transcript or cDNA thereof whose identity or abundance is sought to be detected by using the probe, and in particular refers to an individual gene for which a probe molecule is made. In certain contexts, “targeting” means binding or causing to be bound the probe molecule to the endogenously expressed transcript or cDNA thereof. The target nucleotide sequence may be selected without limitation from any genes.

As used herein, “target cDNA library” used with respect to the target library refers to a collection of all of the mRNA molecules present in a cell or organism, all turned into cDNA molecules with the enzyme reverse transcriptase, so that the library can then be probed for the specific cDNA (and thus mRNA) of interest.

As used herein, “target-probe binding” means two or more molecules, at least one being a selected molecule, attached to one another in a specific manner. Typically, a first selected molecule may bind to a second molecule that either indirectly, e.g., through an intervening spacer arm, group, molecule, bridge, carrier, or specific recognition partner, or directly, i.e., without an intervening spacer arm, group, molecule, bridge, carrier or specific recognition partner, advantageously by direct binding. A selected molecule may specifically bind to a nucleotide via hybridization. Other noncovalent means for conjugation of nucleotide and normucleotide molecules include, e.g., ionic bonding, hydrophobic interactions, ligand-nucleotide binding, chelating agent/metal ion pairs or specific binding pairs such as avidin/biotin, streptavidin/biotin, anti-fluorescein/fluorescein, anti-2,4-dinitrophenol (DNP)/DNP, anti-peroxidase/peroxidase, anti-digoxigenin/digoxigenin or, more generally, receptor/ligand. For example, a reporter molecule such as alkaline phosphatase, horseradish peroxidase, β-galactosidase, urease, luciferase, rhodamine, fluorescein, phycoerythrin, luminol, isoluminol, an acridinium ester or a fluorescent microsphere which is attached, e.g., for labeling purposes, to a selected molecule or selected nucleic acid sequence using avidin/biotin, streptavidin/biotin, anti-fluorescein/fluorescein, anti-peroxidase/peroxidase, anti-DNP/DNP, anti-digoxigenin/digoxigenin or receptor/ligand (i.e., rather than being directly and covalently attached) may be conjugated to the selected molecule or selected nucleic acid sequence by means of a specific binding pair.

Unless the context requires otherwise, the term “ligand” refers to any substance that is capable of binding selectively with a probe. A ligand can be an antigen, an antibody, an oligonucleotide, an oligopeptide (including proteins, hormone, etc.), an enzyme, a substrate, a drug, a drug-receptor, cell surface, receptor agonists, partial agonists, mixed agonists, antagonists, response-inducing or stimulus molecules, drugs, hormones, pheromones, transmitters, autacoids, growth factors, cytokines, prosthetic groups, coenzymes, cofactors, substrates, precursors, vitamins, toxins, regulatory factors, antigens, haptens, carbohydrates, molecular mimics, structural molecules, effector molecules, selectable molecules, biotin, digoxigenin, crossreactants, analogs, competitors or derivatives of these molecules as well as library-selected nonoligonucleotide molecules capable of specifically binding to selected targets and conjugates formed by attaching any of these molecules to a second molecule, and any other molecule that binds selectively with a corresponding probe.

Unless the context requires otherwise, the term “probe” refers to any substance that is bound to a substrate surface and is capable of binding selectively with a corresponding ligand. A probe can be an antigen, an antibody, an oligonucleotide, an oligopeptide (including proteins, hormone, etc.), an enzyme, a substrate, a drug, a drug-receptor, cell surface, and any other molecule that binds selectively with a corresponding ligand.

It should be appreciated that the terms “ligand” and “probe” do not refer to any particular substance or size relationship. These terms are only operational terms that indicate selective binding between the ligand and the corresponding probe where the moiety that is bound to a substrate surface is referred to as a probe and any substance that selectively binds to the probe is referred to as a ligand. Thus, if an antibody is attached to the substrate surface then the antibody is a probe and the corresponding antigen is a ligand. However, if an antigen is attached to the substrate surface then the antigen is a probe and the corresponding antibody is a ligand.

The concentration of a probe on a substrate surface is one of the key factors that govern interactions between immobilized probe and their corresponding ligand. In spite of several advantages, probes immobilized at high densities frequently have chemical and biological properties that are substantially different from those of the same probe presented in a natural environment. Moreover, non-inert probes of a high density may promote nonspecific probe-ligand interaction. Varying the density of surface bound probes to relieve the surface materials from steric hinderance while also maintaining signal intensities, specificity, and an apparent binding capacity sufficient for applications such as biosensors and biochips, is desirable.

Conventionally, the functional group densities of the thin film are commonly adjusted by co-deposition of both an inert adsorbate and a functionalized one. However, phase separation into microscopic or nanoscopic domains with distinct functional groups is difficult to prevent especially when strong inter-group interactions are present.

Compositions and methods of the invention provide the probe density that significantly reduces the phase separation. Some embodiments of the invention provide a substrate comprising a plurality of conically shaped dendrimers on its surface. Within these embodiments, in some instances the terminus of each dendrimer is capable of binding to the substrate surface and the apex of each dendrimer is reactive for the immobilization of probes.

Detection of Target DNA Using Bio-AFM for Genotyping

DNA microarray is a revolutionary tool for high throughput, multiplexed analyses of large number of genes. It is important to develop highly sensitive detection methods for the microarray-based analysis as sometimes only minute amounts of genetic material is available. Typically, the signal output is enhanced through amplification methods, which are classified into two classes, i.e., target amplification and signal amplification.¹⁹ The advantages and shortcomings of target amplification in gene expression analyses were recently reviewed.²⁰ Despite the wide applicability, the target amplification by PCR has drawbacks such as contamination of the material through amplicon carry-over, limited ability for multiplexing, variations in amplification efficiency, etc. Amplification of mRNA from a sample of small copies also suffers from distortion of pristine RNA ratio and increased noise ratio.²¹

In addition, most biochemical assays require secondary detection of a label, because biomolecules lack intrinsic properties that are useful for direct high-sensitivity detection. The most commonly used labels in biological diagnostics are organic fluorescent dyes. But organic dyes still suffer from limitations such as photobleaching and discrete excitation bands that preclude their use in many applications.

In previous study, we have shown how nanoscale-engineered dendron surfaces comprising arrays of complementary DNA oligonucleotides can provide measurable forces of attraction and adhesion that relate to hybridization events. Importantly, we have been able to use this system to detect attractive and adhesive forces that could discriminate between DNA duplexes with 10 base pairs difference and have shown that this measurement method is also sensitive to detection of single and double base-pair mismatches. ¹⁷

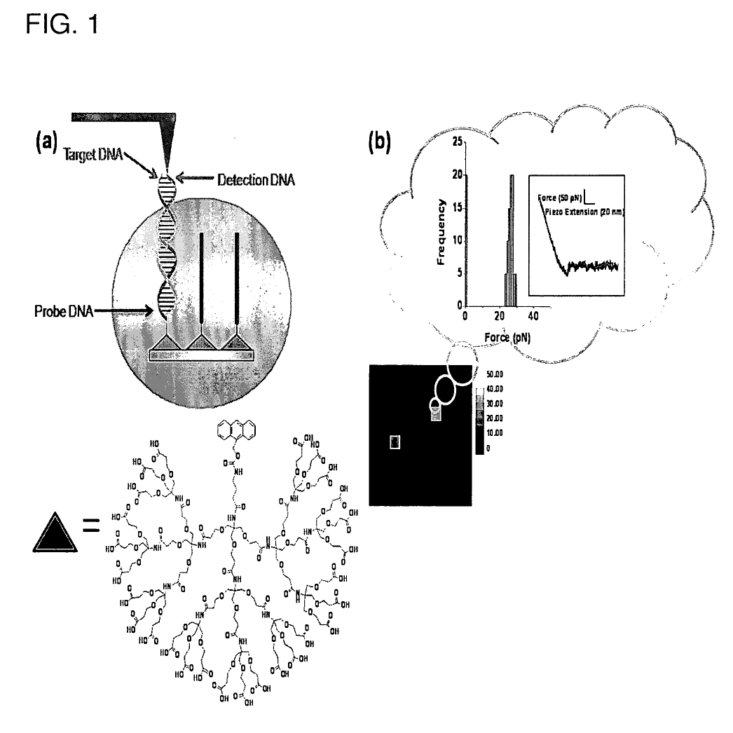

As described in Examples 1-4 below, when 1 aM of a target DNA (35 oligomer) was hybridized with a probe DNA on dendron-modified surface (15 oligomer), the probability to measure the specific force (26±0.6 pN by Gaussian fitting in histogram curves) between target DNA and detection DNA was 80% and no force was observed at 20% force-distance curves (FIG. 1 (b)). The inventive method shows a sensitivity of ≦10³ target molecules detectable without labeling, a level that is better than the 10⁵ number achievable with a high-density microarray system, and approaching the 10³-10⁴ level usually observed for quantitative PCR (qPCR).

Thus, because dendron-modified surface can be used as a platform to detect even a single base mutation, the inventive AFM system can be applied not only to genotyping but also detection of single nucleotide polymorphism (SNP) in target DNAs. For single base mismatched target DNAs, the number of the target DNAs bound to probe DNAs on the surface are smaller than that of complementary target DNAs. Therefore, by measuring decrease of the number of surface-bound target DNAs, we can discriminate complementary target DNAs from single base mismatched ones.

Detection of cDNA Target Using a Bio-AFM for Gene Expression Profiling Studies.

In general, expression profiling studies report those genes that showed statistically significant differences under changed experimental conditions. Both DNA microarrays and qPCR exploit the preferential binding or “base pairing” of complementary nucleic acid sequences, and both are used in gene expression profiling, often in a serial fashion. While high throughput DNA microarrays lack the quantitative accuracy of qPCR, it takes about the same time to measure the gene expression of a few dozen genes via qPCR as it would to measure an entire genome using DNA microarrays. So it often makes sense to perform semi quantitative DNA microarray analysis experiments to identify candidate genes, and then perform qPCR on some of the most interesting candidate genes to validate the microarray results. However, the inventive Bio-AFM can combine several advantages of DNA microarray and qPCR.

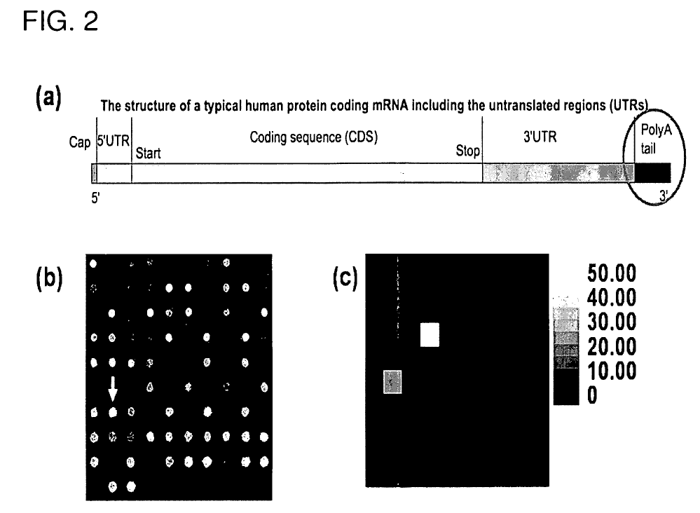

Polyadenylation occurs after transcription of DNA into RNA in the nucleus. After the polyadenylation signal has been transcribed, the mRNA chain is cleaved through the action of an endonuclease complex associated with RNA polymerase. The cleavage site is characterized by the presence of the base sequence AAUAAA near the cleavage site. After the mRNA has been cleaved, 50 to 250 adenine residues are added to the free 3′ end at the cleavage site. This reaction is catalyzed by polyadenylate polymerase (FIG. 2(a)). As seen in the Examples 1-4 below, the sensitivity of Bio-AFM measurement was increased 10⁵ times as microarray (FIG. 2 (c)).

Microarray System

Various specific array types comprising probe molecules are provided by the present invention to identify differentially expressed genes in cells or tissues of diverse animals, plants, and microorganisms. These array types include, but not limited to the following: developmental array; cancer array; apoptosis array; oncogene and tumor suppressor array; cell cycle gene array; cytokine and cytokine receptor array; growth factor and growth factor receptor array; neuroarray; and so on.

The arrays of the present invention can be used in, among other applications, differential gene expression assays. For example, the arrays may be useful in the differential expression analysis of: (a) disease states, e.g., neoplastic or normal; (b) different tissue types; (c) developmental stages; (d) responses to external or internal stimulus; (e) responses to treatment; etc. The arrays may also be useful in broad scale expression screening for drug discovery and research. In addition, by studying the effect of an active agent in a particular cell type on gene expression, information for drug toxicity, carcinogenicity, environmental monitoring and the like can be obtained and analyzed.

In one aspect, the invention includes a substrate with a surface having a microarray of at least 103 distinct probe molecules in a surface area of less than about 1 cm². Each distinct probe molecule (i) is disposed at a separate, defined position in the array, and (ii) is present in a defined amount between about 0.1 femtomoles and 100 nanomoles.

The cells from which the target cDNA is obtained may be chosen from cells of interest such as normal cells or from cells of various types of cancer, such as liver cancer, lung cancer, stomach cancer, breast cancer, bladder cancer, rectal cancer, colon cancer, prostate cancer, thyroid cancer, and skin cancer as well as cells of obesity, hair follicles, auto-immune disorders, and metabolic disorders.

In a preferred embodiment, each microarray contains at least 103 distinct probe molecules per surface area of less than about 1 cm². The microarray may contain at least about 400 regions in an area of about 16 mm², or 2.5×10³ regions/cm². Also in a preferred embodiment, the probe molecules in each microarray region may be present in a defined amount between about 0.1 femtomoles and 100 nanomoles in the case of polynucleotides.

Also in a preferred embodiment, the proble polynucleotides have lengths of at least about 10 nucleotides, which can be formed in high-density arrays by various in situ synthesis schemes.

Dendrons

Some aspects of the invention provide an array of dendrons. Generally, the array comprises a solid support having at least a first surface and a plurality of dendrons attached to the first surface of the solid support. Each of the dendron typically comprises a central atom; a functional group or a protected form of the functional group that is attached to the central atom optionally through a linker; and a base portion attached to the central atom and having a plurality of termini that are attached to the first surface of the solid support. As used herein, the term “central atom” refers to a focal point atom from which the branches emanate. For example, the central atom is represented in Formula I, below, as Q¹. The term “base portion” when referring to a dendron refers to a moiety comprising a plurality of branches emanating from the central atom. In some embodiments, the dendron can be described or schematically illustrated as being conically-shaped with the base portion of the cone being bound to the solid support surface.

The functional group (or moiety) refers to an atom or a group of atoms within a molecule that are responsible for the chemical reaction. Generally, a functional group comprises a heteroatom (such as halogen, oxygen, nitrogen, sulfur, phosphorous, etc.) or an unsaturation (e.g., carbon-carbon double or triple bond). Exemplary functional groups include, but are not limited to, acyl halides, alcohols, ketones, aldehydes, carbonates (including esters), carboxylates, carboxylic acids, ethers, hydroperoxides, peroxides, halides, olefins, alkynes, amides, amines, imines, imides, azides, azo, cyanates, isocyanates, nitrates, nitriles, nitrites, nitro, nitroso, phosphines, phosphodiesters, phosphonic acids, phosphonates, sulfides, thioethers, sulfones, sulfonic acids, sulfoxides, thiols, thiocyanates, disulfides, thioamides, thioesters, thioketones. Often functional group undergoes a nucleophilic reaction or an electrophilic reaction. In some embodiments, the functional group of the dendron is capable of participating in a nucleophilic reaction. As such, the functional group can be a nucleophile or an electrophile. Often the functional group is adapted for attaching a probe. In one particular instance, the functional group is capable of forming a bond with the probe by a nucleophilic substitution reaction.

The functional group is used to attach a wide variety of probes, which can then be used to detect the presence of a corresponding ligand in a fluid medium. Typically, when the functional group is attached to a probe, the discrimination efficiency (e.g., the amount of target specific binding relative to non-specific binding) of the probe is at least about 50%, often at least about 70%, more often at least about 80%, and most often at least about 90%. In one particular embodiment, when the functional group is attached to an oligonucleotide probe of 15 nucleotides and an oligonucleotide target of 15 nucleotides in solution is used, the single nucleotide polymorphism (SNP) discrimination efficiency is at least about 80% (1:0.2), often at least about 90% (1:0.1), more often at least about 95% (1:0.05), and more often at least 99% (1:0.01).

The discrimination efficiency of the probe can be determined by any of the variety of methods, for example, by comparing the efficiency and/or selectivity of the probe-ligand complex formation under substantially a similar reaction condition. SNP discrimination efficiency can also be determined in a similar fashion. One exemplary method of measuring the discrimination efficiency is to compare the signal strength of the target-specific probe bound to the substrate surface with that of target-nonspecific probe bound to the substrate. For example, if a target-specific probe bound to the substrate surface produces a signal strength of 100 at 10 nM target concentration and the target-nonspecific probe bound to the substrate surface produces a signal strength of 30 at the same target concentration, then the discrimination efficiency of the probe on the substrate surface is (100-30)/100 or 70% (1:0.3).

In some embodiments, when the functional group is attached to an oligonucleotide probe of 15-21 nucleotides, the signal strength of target-nonspecific oligonucleotide probe (e.g., an oligonucleotide probe having at least one, often at least two, and more often at least three different nucleotide from a target-specific oligonucleotide probe) bound to the substrate is reduced by at least about 70%, often by at least about 80%, more often by at least about 95%, and still more often by at least about 99% compared to the signal strength of the target-specific oligonucleotide probe (e.g., an oligonucleotide probe perfectly complementary to total or part of a target DNA) bound to the substrate. Generally, different oligonucleotide probes may have different discrimination efficiency.

In one particular embodiment, when the functional group is attached to an oligonucleotide probe of 15 nucleotides, the relative amount of non-specific binding to the amount of specific binding is reduced by at least about 50%, often at least about 60%, more often at least 80%, and still more often at least about 90% compared to the oligonucleotide probe attached to a non-dendron. Again, one method of measuring the non-specific binding is those described herein including those in the Examples section. One particular method of determining reduction of the relative amount of non-specific binding is given by the following formula:

[(A−B)/A]×100%

where A is the relative amount of non-specific binding using a non-dendron molecule (e.g., APDES-modified surface), and B is the relative amount of non-specific binding using a dendron modified surface. The relative amount of non-specific binding to the amount of the specific binding for C:T mismatch may be reduced by at least 95% [(0.12-0.006)/0.12×100% 95%].

Yet in other embodiments, the functional group or the optional linker that is attached to the apex of the dendron does not form an α-helix. Without being bound by any theory, it is believed that the presence of an α-helix reduces the discrimination efficiency and/or increases the non-specific binding, thereby reducing the usefulness of the dendron.

In some aspects of the invention, the dendron is of the formula:

Z-[R¹]ₘ-Q¹-{[R²-Q²]ₐ-{(R³-Q³)_{b}-[(R⁴-Q⁴)_{c}-(R⁵—Y)ₓ]_{y}}_{z}}ₙ I

where
each of m, a, b, and c is independently 0 or 1;
x is 1 when c is 0 or when c is 1, x is an integer from 1 to the oxidation state of Q⁴-1;
y is 1 when b is 0 or when b is 1, y is an integer from 1 to the oxidation state of Q³-1;
z is 1 when a is 0 or when a is 1, z is an integer from 1 to the oxidation state of Q²-1;
n is an integer from 1 to the oxidation state of Q¹-1;
Q¹ is a central atom having the oxidation state of at least 3;
each of Q², Q³ and Q⁴ is independently a branch atom having the oxidation state of at least 3;
each of R¹, R², R³, R⁴, and R⁵ is independently a linker; Z is the functional group that is optionally protected; and
each of Y is independently a functional group on the terminus of said base portion, wherein a plurality of Y are attached to said first surface of said solid support,
provided the product of n, x, y, and z is at least 3.

It should be appreciated that when a, b or c is 1 and the corresponding z, y or x is less than the oxidation state of Q²-1, Q³-1 or Q⁴-1, respectively, the remaining atoms attached to Q², Q³, or Q⁴, respectively, is hydrogen. As used herein, “Q” refers to any one of or all of Q¹, Q², Q³, Q⁴. Typically, Q is any atom in group IVA or VA of the periodic table. Exemplary atoms for Q include, but are not limited to, N, P, C, Si, Ge, and the like. Often, Q is N, P, C, or Si.

As can be seen in Formula I, Z is attached to the central atom optionally through a linker R¹. Often, a is 1 such that Z is attached to the central atom through a linker R¹. Moreover, Z or its unprotected form (i.e., when Z is a protected functional group) is adapted for attaching a probe. In some embodiments, Z is a nucleophile. A nucleophile is an atom or a group of atoms that forms a chemical bond with its reaction partner (i.e., the electrophile) by donating both bonding electrons. Typically, the nucleophile is a heteroatom such as N, P, O, and S, or a carbanion particularly a carbanion that is stabilized by resonance and/or by the presence of nearby electron withdrawing group(s). One skilled in the art of organic chemistry can readily recognize suitable nucleophiles for the dendron of Formula I. Some of the representative nucleophiles are disclosed above in exemplary functional groups.

In other embodiments, Z is an electrophile. An electrophile is an atom or a group of atoms that are attracted to electrons and participates in a chemical reaction by accepting an electron pair in order to bond to a nucleophile. Most electrophiles are positively charged, have an atom which carries a partial positive charge, or have an atom which does not have an octet of electrons. Typically, the electrophile is a carbon atom that has at least a positive dipole moment due to one or more electronegative atoms (e.g., halides or other heteroatoms) that are attached to or are near the electrophilic center. One skilled in the art of organic chemistry can readily recognize suitable electrophiles for the dendron of Formula I. Some of the representative electrophiles are disclosed above in exemplary functional groups.

Yet in other embodiments, Z comprises a heteroatom selected from the group consisting of N, O, S, P, and a combination thereof.

Each Y can be independently a functional group. That is, each Y can be independent of the other Y group. Often, however, all of the Y's are the same functional group. However, in general Z and Y are different functional groups. In some instances, Z and Y can be the same functional group, but one or the other is in a protected form. Such differences in functional group and/or the presence of a protecting group allow one to distinguish the reactivity of Z and Y, thereby allowing one to attach the dendron to the solid support via a plurality of Y's and allows attachment of a probe on Z.

Linker

Referring again to Formula I, the dendron generally comprises various linkers, e.g., R¹, R², R³, R⁴, R⁵. Each linker is connected to another linker by a branch atom Q², Q³, or Q⁴. The terminal linker comprises functional group Y so that it is capable of binding to the solid support.

The length of each of the linker may be determined by a variety of factors, including the number of branched functional groups binding to the solid support, strength of the binding to the solid support, spacing desired, etc. Therefore, it is understood that the linker is not to be limited to any particular type of chain or polymer of any particular length. However, as a general guideline, the length of the linker may be from about 0.5 nm to about 20 nm, typically from about 0.5 nm to about 10 nm, and often from about 0.5 nm to about 5 nm. Alternatively, each linker is independently a chain having from about 1 to about 100 atoms, typically from about 1 to about 50 atoms, often from about 1 to about 25 atoms, and more often about 3 atoms to about 10 atoms in chain length. The chemical construct of the linker include without limitation, a linear or branched organic moiety, such as but not limited to substituted or unsubstituted alkyl, alkenyl, alkynyl, cycloalkyl, cycloalkenyl, aryl, ether, polyether, ester, aminoalkyl, polyalkenylglycol and so on.

Linkers R¹, R², R³, R⁴, R⁵ can be the same or different. Typically, each linker is a repeating unit, a linear or branched organic moiety. However, it is also understood that not all the linkers need to be the same repeating unit. Nor do all valence positions for a linker need be filled with a repeating unit. For example, all of the R² can be the same repeating units. Or one or two of the R² may be a repeating unit, and the remaining R²'s may be H or other chemical entities. Likewise, one or two of each of R³, R⁴, or R⁵ may be, independently, a repeating unit, H or any other chemical entity. Thus, a variety of shapes of polymers may be made in this way. Accordingly, it is possible that a dendron can have from about 3 to about 81 Y functional groups. Typically, the dendron has from about 6 to about 81 Y functional groups, from about 6 to about 54 Y functional groups, from about 6 to about 27 Y functional groups, from about 8 to about 27 Y functional groups, from about 9 to about 27 Y functional groups, from about 9 to about 18 Y functional groups, or from about 9 to about 12 Y functional groups.

Functional Group Y

Each of functional group Y is sufficiently reactive to undergo addition or substitution reactions. The functional group (or moiety) refers to an atom or a group of atoms within a molecule that are responsible for the chemical reaction. Generally, a functional group comprises a heteroatom (such as halogen, oxygen, nitrogen, sulfur, phosphorous, etc.) or an unsaturation (e.g., carbon-carbon double or triple bond). Exemplary functional groups include, but are not limited to, acyl halides, hydroxy, ketones, aldehydes, carbonates (including esters), carboxylates, carboxylic acids, urea, ethers, hydroperoxides, peroxides, oxiranyl, halides, olefins, alkynes, amides, amines, imines, imides, azides, aziridinyl, azo, cyanates, isocyanates, nitrates, nitriles, nitrites, nitro, nitroso, oxazolinyl, imidazolinyl, phosphines, phosphodiesters, phosphonic acids, phosphonates, sulfides, thioethers, sulfones, sulfonic acids, sulfoxides, thiols, thiocyanates, isothiocyanantes, disulfides, thioamides, thioesters, thioketones, silanyl, as well as other groups that are known to undergo a chemical reaction. Often functional group undergoes a nucleophilic reaction or an electrophilic reaction.

Protecting Group

When present, the choice of protecting group depends on numerous factors. Therefore, the invention is not limited to any particular protecting group so long as it serves the function of preventing the reaction of the functional group to another chemical entity, and that it is capable of being removed under desired specified conditions. Typically, the protecting group used can be removed relatively easily.

Exemplary suitable protecting groups include without limitation the following:

Amino acid protecting groups: Methyl, Formyl, Ethyl, Acetyl, t-Butyl, Anisyl, Benzyl, Trifluoroacetyl, N-hydroxysuccinimide, t-Butyloxycarbonyl, Benzoyl, 4-Methylbenzyl, Thioanizyl, Thiocresyl, Benzyloxymethyl, 4-Nitrophenyl, Benzyloxycarbonyl, 2-Nitrobenzoyl, 2-Nitrophenylsulphenyl, 4-Toluenesulphonyl, Pentafluorophenyl, Diphenylmethyl (Dpm), 2-Chlorobenzyloxycarbonyl, 2,4,5-trichlorophenyl, 2-bromobenzyloxycarbonyl, 9-Fluorenylmethyloxycarbonyl, Triphenylmethyl, 2,2,5,7,8-pentamethyl-chroman-6-sulphonyl, Phthaloyl, 3-Nitrophthaloyl, 4,5-dichlorophthaloyl, tetrabromophthaloyl, and tetrachlorophthaloyl.

Hydroxy protecting groups: p-Anisyloxymethyl (p-AOM), Benzyloxymethyl (BOM), t-Butoxymethyl, 2-Chlorotetrahydrofuran (THF), Guaiacolmethyl (GUM), (1R)-Menthoxymethyl (MM), p-Methoxybenzyloxymethyl (PMBM), metoxyethoxymethyl (MEM), Methoxymethyl (MOM), o-Nitrobenzyloxymethyl, (Phenyldimethylsilyl)methoxymethyl (SMOM), and 2-(Trimethylsilyl)ethoxymethyl (SEM).

DNA, RNA protecting reagent: 2′-OMe—Ac—C-CE Phosphoramidite, 2′-OMe—Ac-RNA CPG, 2′-OMe-1-CE Phosphoramidite, 2′-OMe-5-Me-C-CE Phosphoramidite, Ac—C-CE Phosphoramidite, Ac—C-RNA 500, dmf-dG-CE Phosphoramidite, dmf-dG-CPG 500, and 2-Amino-dA-CE Phosphoramidite.

Other suitable protecting groups for various functional groups are well known to one skilled in the art. See, for example, T. W. Greene and P. G. M. Wuts, Protective Groups in Organic Synthesis, 3 edition, John Wiley & Sons, New York, 1999, and Harrison and Harrison et al., Compendium of Synthetic Organic Methods, Vols. 1-8 (John Wiley and Sons, 1971-1996)

Table 1 below lists various types of exemplified compounds. However, it is to be understood that variations in X, R¹, Q, R and Y are encompassed by the present invention.

TABLE 1
Representative and Exemplified Macromolecule Compounds

| Cpd No. | X | R¹ | Q | R | Y |
|---|---|---|---|---|---|
| 3-1 | A | NH—(CH₂)₃C(O)NH | C | CH₂O(CH₂)₂C(O) | OH |
| 3-2 | A | NH—(CH₂)₃C(O)NH | C | CH₂O(CH₂)₂C(O) | OMe |
| 3-3 | Boc | NH—(CH₂)₃C(O)NH | C | CH₂O(CH₂)₂C(O) | OH |
| 3-4 | Boc | NH—(CH₂)₃C(O)NH | C | CH₂O(CH₂)₂C(O) | OMe |
| 3-5 | A | NH—(CH₂CH₂O)₂CH₂C(O)NH | C | CH₂O(CH₂)₂C(O) | OH |
| 3-6 | A | NH—(CH₂CH₂O)₂CH₂C(O)NH | C | CH₂O(CH₂)₂C(O) | OMe |
| 6-1 | A | NH—(CH₂)₃C(O)NH | C | CH₂O(CH₂)₂C(O) | OH |
| 6-2 | Boc | NH-(cyclohexyl)(CO)CH₂ | C | (CH₂)₂-(cyclohexyl)-C(O) | NH₂ |
| 6-3 | Boc | NH—(CH₂CH₂O)₂CH₂C(O)NH | C | CH₂O(CH₂)₂C(O) | OH |
| 6-4 | Fmoc | NH—(CH₂)₆NHC(O)NH | C | CH₂—C═C—CH₂C(O) | OH |
| 6-5 | Fmoc | NH—(CH₂)₇C(O)O | C | CH₂—C═C—CH₂C(O) | OMe |
| 6-6 | NS | NH-(cyclohexyl)(CO)O | C | CH₂O(CH₂)₂C(O) | NH₂ |
| 6-7 | NS | NH—(CH₂)₆NHC(O)NH | C | (CH2)₇ | NH₂ |
| 8-1 | A | NH—(CH₂)₃C(O)NH | C | CH₂O(CH₂)₂C(O) | OH |
| 8-2 | Boc | NH—(CH₂)₇C(O)NH | C | (CH2)₂C(O) | OH |
| 8-3 | NS | NH—(CH₂)₆(CO)NH | C | (CH2)₂-(cyclohexyl)-C(O) | OH |
| 8-4 | Fmoc | NH—(CH₂)₆(CO)O | C | CH₂—C═C—CH₂C(O) | NH₂ |
| 8-5 | Fmoc | NH—(CH₂)₆NH(CO)O | C | (CH2)₂-(cyclohexyl)-C(O) | OH |
| 8-6 | NS | NH-(cyclohexyl)(CO)O | C | CH₂OCH(CH₃)CH₂C(O) | NH₂ |
| 8-7 | Boc | NH-(cyclopropyl)(CO)O | C | CH₂—C═C—CH₂C(O) | NH₂ |
| 9-1 | A | NH—(CH₂)₃C(O)NH | C | CH₂O(CH₂)₂C(O) | OH |
| 9-2 | A | NH—(CH₂)₃C(O)NH | C | CH₂O(CH₂)₂C(O) | OMe |
| 9-3 | A | NH—(CH₂CH₂O)₂CH₂C(O)NH | C | CH₂O(CH₂)₂C(O) | OH |
| 9-4 | A | NH—(CH₂CH₂O)₂CH₂C(O)NH | C | CH₂O(CH₂)₂C(O) | OMe |
| 9-5 | Fmoc | NH—(CH₂)₆C(O)NH | C | CH₂O(CH₂)₂C(O) | OH |
| 9-6 | Fmoc | NH—(CH₂)₆C(O)NH | C | CH₂O(CH₂)₂C(O) | OMe |
| 9-7 | Boc | NH—(CH₂)₃C(O)NH | C | CH₂O(CH₂)₂C(O) | OH |
| 9-8 | Boc | NH—(CH₂)₃C(O)NH | C | CH₂O(CH₂)₂C(O) | OMe |
| 9-9 | Ns | NH—(CH₂)₃C(O)NH | C | CH₂O(CH₂)₂C(O) | OH |
| 9-10 | Ns | NH—(CH₂)₃C(O)NH | C | CH₂O(CH₂)₂C(O) | OMe |
| 9-11 | A | NH—(CH₂)₆NHC(O)CH₂CH₂ | C | (CH2)₇ | OBzl |
| 12-1 | A | NH—(CH₂)₃C(O)NH | C | CH₂O(CH₂)₂C(O) | OH |
| 12-2 | Fmoc | NH—(CH₂)₆NHC(O)NH | C | (CH2)₂-(cyclohexyl)-C(O) | NH₂ |
| 12-3 | Boc | NH-(cyclohexyl)(CO)O | C | CH₂—C═C—CH₂C(O) | OMe |
| 12-4 | Boc | NH—(CH₂)₅NH | C | CH₂OCH(CH₃)CH₂C(O) | NH₂ |
| 12-5 | NS | NH-(cyclopropyl)(CO)CH₂ | C | (CH2)₂ | NH₂ |
| 12-6 | NS | NH—(CH₂)₆C(O)O | C | CH₂OCH₂CH(CH₃)C(O) | NH₂ |
| 12-7 | Fmoc | NH—(CH₂)₆NHC(O)O | C | CH₂OCH(CH₃)CH₂C(O) | NH₂ |
| 16-1 | Boc | NH—(CH₂)₃C(O)NH | C | CH₂O(CH₂)₂C(O) | NH₂ |
| 16-2 | Boc | NH-(cyclohexyl)(CO)CH₂ | C | (CH2)₂-(cyclohexyl)-C(O) | OH |
| 16-3 | Fmoc | NH—(CH₂CH₂O)₂CH₂C(O)O | C | CH₂O(CH₂)₂C(O) | OH |
| 16-4 | Fmoc | NH—(CH₂)₆NHC(O)NH | C | (CH₂)₂-(cyclohexyl)-C(O) | NH₂ |
| 16-5 | NS | NH-(cyclohexyl)(CO)NH | C | CH₂—C═C—CH₂C(O) | OH |
| 16-6 | NS | NH-(cyclopropyl)(CO)CH₂ | C | CH₂O(CH₂)₂C(O) | OMe |
| 16-7 | A | NH-(cyclopropyl)(CO)CH₂ | C | CH₂OCH(CH₃)CH₂C(O) | OH |
| 16-8 | A | NH-(cyclopropyl)(CO)CH₂ | C | CH₂OCH₂CH(CH₃)C(O) | NH₂ |
| 16-9 | A | NH—(CH₂)₅O | C | CH₂OCH₂CH(CH₃)C(O) | OH |
| 18-1 | A | NH—(CH₂)₃C(O)NH | C | CH₂O(CH₂)₂C(O) | OH |
| 18-2 | Fmoc | NH-(cyclohexyl)(CO)O | C | CH₂OCH(CH₃)CH₂C(O) | NH₂ |
| 18-3 | Boc | NH-(cyclopropyl)(CO)O | C | CH₂OCH₂CH(CH₃)C(O) | NH₂ |
| 18-4 | Fmoc | NH—(CH₂)₆NHC(O)CH₂NH | C | (CH2)₂-(cyclohexyl)-C(O) | OH |
| 18-5 | NS | NH—(CH₂)₆NHC(O)CH₂ | C | CH₂—C═C—CH₂C(O) | OMe |
| 18-6 | Boc | NH—(CH₂)₅O | C | CH₂OCH₂CH(CH₃)C(O) | NH₂ |
| 27-1 | A | NH—(CH₂)₃C(O)NH | C | CH₂O(CH₂)₂C(O) | OH |
| 27-2 | A | NH—(CH₂)₆NHC(O)CH₂CH₂ | C | (CH2)₇ | OH |
| 27-3 | Fmoc | NH—(CH₂CH₂O)₂CH₂C(O)O | C | (CH2)₂-(cyclohexyl)-C(O) | NH₂ |
| 27-4 | NS | NH-(cyclopropyl)(CO)NH | C | (CH2)₂-(cyclohexyl)-C(O) | NH₂ |
| 27-5 | Boc | NH-(cyclohexyl)(CO)CH₂ | C | CH₂OCH(CH₃)CH₂C(O) | OMe |
| 27-6 | Fmoc | NH—(CH₂)₅O | C | CH₂OCH₂CH(CH₃)C(O) | NH₂ |

In some aspects of the invention, the solid support is a non-porous solid substrate. Suitable non-porous solid substrates include, but not limited to, metals, metal alloys, ceramics, plastics, silicon, and silicates (such as glass and semi-conductor wafer). The solid support can be in the form of a slide, particle, bead, or micro-well. In some embodiments, the solid support is a non-porous solid substrate. Within these embodiments, in some instances the solid support is glass.

In other aspects of the invention, the solid support is a porous solid substrate. Exemplary porous materials include, but are not limited to, a membrane, bead (including controlled pore bead), gelatin, and hydrogel.

Another aspect of the invention provides a method for producing a solid support comprising a plurality of dendrons on its surface. The solid support comprises at least a first surface comprising a surface functional group for forming a bond with a dendron. The dendron comprises a central atom; a functional group that is attached to the central atom optionally through a linker; and a base portion attached to the central atom and having a plurality of termini, where each terminus of the base portion comprises a functional group. The method generally involves contacting a plurality of dendrons with the solid support surface under conditions sufficient to form a bond between the surface functional group on the first surface of the solid support and the functional group on the terminus of the base such that a plurality of bonds are formed between the base portion of the dendron and the first surface of the solid support.

In some embodiments, the bond that formed between the surface functional group on the first surface of the solid support and the functional group on the terminus of the base is a covalent bond.

Yet in other embodiments, the bond between the surface functional group on the first surface of the solid support and the functional group on the terminus of the base is formed by a nucleophilic substitution reaction. Reaction conditions for a suitable nucleophilic substitution reaction are well known to one skilled in the art. See, for example, Harrison and Harrison et al., Compendium of Synthetic Organic Methods, Vols. 1-8 (John Wiley and Sons, 1971-1996).

A variety of solid supports can be used in methods of the invention. Suitable solid supports are discussed herein and include non-porous as well as porous solid supports. Exemplary solid supports that can be used include those given above. In some embodiments, the solid support is a non-porous solid support. Within these embodiments, in some instances, the solid support is a non-porous solid support. In one particular embodiments, the non-porous solid support is a glass.

In some embodiments, the functional group that is attached to the central atom optionally through a linker is protected prior to attaching the dendron to the solid support surface to reduce or prevent its reactivity. In this manner, the functional group attached to the central atom (or the one that is present on the apex of the dendron) remains relatively inert under the reaction conditions while the functional group on the terminus of the base undergoes bond forming reaction with the surface functional group on the solid support. Use of a protecting group to reduce or prevent reactivity of a particular functional group is well known to one of ordinary skill in the art. See, for example, T. W. Greene and P. G. M. Wuts, Protective Groups in Organic Synthesis, 3rd edition, John Wiley & Sons, New York, 1999, and Harrison and Harrison et al., Compendium of Synthetic Organic Methods, Vols. 1-8 (John Wiley and Sons, 1971-1996), which are incorporated herein by reference in their entirety. Representative hydroxy protecting groups include acyl groups, benzyl and trityl ethers, tetrahydropyranyl ethers, trialkylsilyl ethers and allyl ethers. Representative amino protecting groups include, formyl, acetyl, trifluoroacetyl, benzyl, benzyloxycarbonyl (CBZ), tert-butoxycarbonyl (Boc), trimethyl silyl (TMS), 2-trimethylsilyl-ethanesulfonyl (SES), trityl and substituted trityl groups, allyloxycarbonyl, 9-fluorenylmethyloxycarbonyl (FMOC), nitro-veratryloxycarbonyl (NVOC), and the like. It should be appreciated, however, that in some instances the reactivity of the functional group on the base terminus and the reactivity of the functional that is attached to the central atom optionally through a linker (i.e., “apex functional group”) is sufficiently different enough to allow attachment of the dendrons onto the solid substrate surface without the need to protect the apex functional group.

Once the dendron is attached to the solid support, the protecting group, if present, can be removed from the apex functional group. A desired probe can then be attached to the apex functional group using a suitable reaction condition.

In some embodiments, the dendrons are attached to predefined regions of the solid support. Such attachments can be achieved using any of the variety of methods known to one skilled in the art, for example, by using a wet or dry coating technology.

Other aspects of the invention provide methods for detecting a presence of a ligand in a fluid medium using a solid support that comprises an array of dendrons on its surface. The base portion of the dendron is attached to the solid support and the apex functional group comprises a probe that is selective for a given ligand. The method generally involves contacting the fluid medium with the solid substrate under conditions sufficient to selectively form a probe-ligand complex if the ligand is present in the fluid medium; and determining the presence of the desired probe-ligand complex. The presence of the desired probe-ligand complex is an indication that the fluid medium comprises the ligand.

In some embodiments, the desired probe-ligand complex is an oligonucleotide-complementary oligo- or polynucleotide complex, an oligopeptide-binding oligo- or polypeptide complex, PNA-complementary oligo- or polynucleotide complex, LNA-complementary oligo- or polynucleotide complex, or a receptor-substrate complex. Within these embodiments, in some instances the receptor-substrate complex comprises a drug-drug receptor complex, an enzyme-enzyme substrate complex, an antibody-antigen complex, or an aptamer-protein complex.

In some embodiments, methods of the invention are capable of discriminating a single nucleotide polymorphism in the oligonucleotide probe-complementary DNA complex, herein the oligonucleotide probe having at least about 75 nucleotide sequences, often having at least about 50 nucleotide sequences, more often having at least about 30 nucleotide sequences, and most often having at least about 15. One method of determining such selectivity is to analyze a DNA microarray with model system and/or codon 175 of the seven hot spots in p53 gene as disclosed in the Examples section.

Still in some embodiments, methods of the invention are capable of discriminating a single amino acid mismatch in the oligopeptide probe-specific peptide target complex, wherein the oligopeptide probe has at least about 200 amino acids, at least about 50 amino acids, at least about 20 amino acids, or at least about 10 amino acids.

The distance between the probes among the plurality of dendrons on the solid support can range from about 0.1 nm to about 100 nm, from about 1 nm to about 100 nm, from about 2 nm to about 50 nm, from about 2 nm to about 30 nm, or from about 2 nm to about 10 nm.

Target-Specific Ligand or Probe

The target-specific ligand, also known as the probe, which may be attached to the polymer includes a variety of compounds, including chemicals, biochemicals, bioactive compounds and so on. In this regard, the probe can be a nucleic acid, an oligonucleotide, RNA, DNA, PNA, LNA, aptamer, antigen, antibody, etc. The oligonucleotide can be a naturally occurring nucleic acid or an analog thereof. Thus, the probe can be a polypeptide composed of naturally occurring amino acids or synthetic amino acids. The probe can be a combination of nucleic acid, amino acid, carbohydrate or any other chemical so long as it is capable of being attached to the functional group of the polymer. In particular, the probe can also be a chemical, such as based on a triazine backbone, which can be used as a component in a combinatorial chemistry library, in particular, a triazine tagged library.

Solid Support

The solid support can be any solid material to which the polymer can be attached. Typically, the polymer binds to the solid support surface through either covalent or ionic bond. The solid support can be functionalized so that bonding occurs with the functional group that is present on the base portion of the polymer. The surface of the solid support can be a variety of surfaces according to the needs of the practitioner in the art. If a microarry or biochip format is desired then typically oxidized silicon wafer, fused silica or glass can be the substrate. In some embodiments, the solid support is a glass slide. Other exemplary solid support includes membrane filters such as but not limited to nitrocellulose or nylon. The solid support can be hydrophilic or polar, and can possess negative or positive charge before or after coating.

Microarray

In order to improve the performance of microarrays, various issues such as probe design, reaction conditions during spotting, hybridization and washing conditions, suppression of non-specific binding, distance between the biomolecules and the surface, and/or the space between the immobilized biomolecules should be considered. Because most of these factors are associated with the nature of the microarray surface, surface optimization has become one of the major goals in microarray research. Some aspects of the present invention provide solid supports comprising surface bound dendrons. In some embodiments, the dendrons are cone-shaped and provide oligonucleotide microarrays with single nucleotide polymorphism (or SNP) discrimination efficiency close to the solution value (1:0.01), reduce non-specific binding, or both.

The surface of a solid support can be prepared using any of the various methods known to one skilled in the art. For example, hydroxylated glass surface can be prepared by using a method disclosed by Maskis et al. in Nucleic Acids Res., 1992, 20, 1679-1684. Solid supports including oxidized silicon wafer, fused silica, and glass slide can be modified with (3-glycidoxypropyl)methyldiethoxysilane (GPDES) and ethylene glycol (EG). Typically, the dendron was attached to the solid support surface using a coupling reaction between the apex functional group of the dendron (e.g., carboxylic acid group) and the functional group on the solid support surface (e.g., hydroxyl group), for example, by using 1-[3-(dimethylamino)propyl]-3-ethylcarbodiimide hydrochloride (EDC) or 1,3-dicyclohexylcarbodiimide (DCC) in the presence of 4-dimethylaminopyridine (DMAP).

In some instances, the increase in thickness after attaching the dendron was 11±2 Å, which is comparable to the ionic bonding. After the immobilization, a UV absorption peak arising from the anthracene moiety of the dendron was observed at 257 nm. The molecular layer was stable enough to show no change in terms of thickness and absorption characteristics upon stirring in dimethylformamide for 1 d. The topographical images obtained by tapping mode atomic force microscope (AFM) also showed that the resulting layer was very smooth and substantially homogeneous without any significant aggregates or holes. Any conventionally known methods for attaching a compound on a solid support surface can be used to produce microarrays of the invention.

In some embodiments, preparation of oligonucleotide microarrays includes deprotecting the apex functional group. It should be appreciated that such step is only necessary if the apex functional group is in a protected form. In cases where the apex functional group is not protected, such step is not necessary. Conventionally, for solid supports with a reactive amine surface group, a thiol-tethered oligonucleotide and a heterobifunctional linker such as succinimidyl 4-maleimido butyrate (SMB) or sulphosuccinimidyl-4-(N-maleimidomethyl)cyclohexane-1-carboxylate (SSMCC) are employed. In contrast, some embodiments of the invention use linkers such as DSC, which allows spotting of amine-tethered oligonucleotides. Thus, some of the advantages of methods and compositions of the invention is the cost effectiveness and avoiding using easily oxidized thiol-tethered oligonucleotide. It should be appreciated, however, that thiol-tethered oligonucleotides can be useful under certain conditions.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

### EXAMPLES

### Example 1

### Materials and Methods

General. The silane coupling agent N-(3-(triethoxysilyl)propyl)-O-polyethyleneoxide urethane (TPU) was purchased from Gelest Inc. All other chemicals are of reagent grade from Sigma-Aldrich. The UV-grade fused-silica plates were purchased from CV1 Laser Co. The polished prime Si (100) wafers (dopant, phosphorus; resistivity, 1.5-2.1 Ω·cm) were purchased from MEMC Electronic Materials Inc. Deionized water (18 MΩ·cm) was obtained by passing distilled water through a Bamstead E-pure 3-Module system.

### Example 2

### Sample Preparation

### Example 2.1

Cleaning the Substrates. Silicon wafers (and fused-silica plates for dendron surface coverage analysis; see the Supporting Information) were sonicated in Piranha solution (concentrated H₂SO₄/30% H₂O₂=7:3 (v/v)) for 4 h (Caution: Piranha solution can oxidize organic materials explosively. Avoid contact with oxidizable materials.). The substrates were washed and rinsed thoroughly with deionized water after sonication. Subsequently, they were immersed in a mixture of deionized water, concentrated ammonia solution, and 30% hydrogen peroxide (5:1:1 (v/v/v)) contained in a Teflon beaker. The beaker was placed in a water bath and heated at 80° C. for 10 min. The substrates were taken out of the solution and rinsed thoroughly with deionized water. Again, the substrates were placed in a Teflon beaker containing a mixture of deionized water, concentrated hydrochloric acid, and 30% hydrogen peroxide (6:1:1 (v/v/v)). The beaker was heated at 80° C. or 10 min. The substrates were taken out of the solution and washed and rinsed thoroughly with a copious amount of deionized water. The clean substrates were dried in a vacuum chamber (30-40 mTorr) for about 20 min and used immediately for the next steps.

### Example 2.2

AFM Probe Pretreatment. Standard V-shaped silicon nitride cantilevers (MLCT-AUNM) with pyramidal tips (Veeco Instruments; k=10 pN/nm) were first oxidized by dipping in 10% nitric acid and heating at 80° C. for 20 min. The cantilevers were taken out of the solution and washed and rinsed thoroughly with a copious amount of deionized water. The clean cantilevers were dried in a vacuum chamber (30-40 mTorr) for about 20 min and used immediately for the next steps.

### Example 2.3

Silylation. Silicon/silica substrates and cantilevers pretreated as above to provide a thin silica top layer were immersed into anhydrous toluene (20 mL) containing the coupling agent (0.20 mL) under a nitrogen atmosphere and placed in the solution for 6 h. After silylation, the substrates and cantilevers were washed with toluene, then baked for 30 min at 110° C. The substrates were immersed in toluene, toluene-methanol (1:1 (v/v)), and methanol in a sequential manner, and they were sonicated for 3 min in each washing solution. The cantilevers were rinsed thoroughly with toluene and methanol in a sequential manner. Finally, the substrates and cantilevers were dried under vacuum (30-40 mTorr). The experimental procedures for silylation with GPDES and subsequent opening of the epoxide with ethylene glycol are described elsewhere.¹⁸

### Example 2.4

Preparation of Dendron-Modified Surfaces. The above hydroxylated substrates and cantilevers were immersed into a methylene chloride solution with a small amount of DMF dissolving the dendron (1.0 mM) and a coupling agent, 1,3-dicyclohexylcarbodiimide (DCC) (27 mM) in the presence of 4-dimethylaminopyridine (DMAP) (2.7 mM) for 4 h. The dendron, 9-anthrylmethyl-3-({[tris({[(1-{tris[(2-{[(tris{[2-carboxyethoxy]methyl}methyl)amino]carbonyl}ethoxy)methyl]methyl}amino)carbonyl]-2-ethoxy}methyl)methyl]amino}carbonyl)propylcarbamate used in this work was prepared in this group. After reaction, the substrates were immersed in methylene chloride, methanol, and water in a sequential manner, and they were sonicated for 3 min at each washing step. The cantilevers rinsed thoroughly with methylene chloride, methanol, and water in a sequential manner. Finally, the substrates and cantilevers were washed with methanol and dried under vacuum (30-40 mTorr).

### Example 2.5

Deprotection of 9-Anthrylmethoxycarbonyl Group. The dendron-modified substrates and cantilevers were immersed into a methylene chloride solution with 1.0 M trifluoroacetic acid (TFA), and they were stirred for 2 h. After the reaction, they were soaked in a methylene chloride solution with 20% (v/v) diisopropylethylamine (DIPEA) for 10 min. The substrates were sonicated in methylene chloride and methanol each for 3 min, and the cantilevers were rinsed thoroughly with methylene chloride and methanol in a sequential manner. The substrates and cantilevers were dried under vacuum (30-40 mTorr).

### Example 2.6

Preparing NHS-Modified Substrates. The above deprotected substrates and cantilevers were immersed into an acetonitrile solution with di(N-succinimidyl)carbonate (DSC) (25 mM) and DIPEA (1.0 mM) for 4 h under nitrogen atmosphere. After the reaction, the substrates and cantilevers were placed in stirred dimethylformamide for 30 min and washed with methanol. The substrates and cantilevers were dried under vacuum (30-40 mTorr).

### Example 2.7

Immobilization of Probe/Detection DNA. The above NHS-modified substrates and cantilevers were soaked in DNA solution (20 μM in 25 mM NaHCO₃ buffer (pH 8.5) with 5.0 mM MgCl₂) for 4 h. After the reaction, the substrates and cantilevers were stirred in a hybridization buffer solution (2×SSPE buffer (pH 7.4) containing 7.0 mM sodium dodecylsulfate) at 37° C. for 30 min and in water for 1 min to remove nonspecifically bound oligonucleotide. Finally the substrates and cantilevers were dried under vacuum (30-40 mTorr).

### Example 2.8

Hybridization of Target DNA. The above probe DNA-tethered substrates were soaked in target DNA solution (20 μM) for 1 h. After the reaction, the substrates were stirred at 37° C. for 30 s and soaked for 1 min in hybridization buffer solution (2×SSPE buffer (pH 7.4) containing 7.0 mM sodium dodecylsulfate) and repeat again. The substrate was washed by 0.2×SSC buffer containing 30 mM sodium chloride and 3.0 mM sodium citrate for 1 min to remove nonspecifically bound oligonucleotide.

### Example 2.9

Immobilization of Probe DNAs for Gene Expression Profiling. For the control experiments, 96 kinds of 10 μM probe DNAs (Homo Sapiens (Human) samples v4.0.1 from Operon company) were immobilized on the Dendron modified glass slide in spotting buffer solution (25 mM NaHCO₃ buffer (pH 8.5) with 5.0 mM MgCl₂) through microarrayer (QArraymini from Genetix) for 4 h. After the reaction, the substrates were stirred in a hybridization buffer solution (2×SSPE buffer (pH 7.4) containing 7.0 mM sodium dodecylsulfate) at 37° C. for 30 min and in water for 1 min to remove nonspecifically bound oligonucleotide. Finally the substrates were dried under vacuum (30-40 mTorr).

### Example 2.10

cDNA Preparation from Reference Total RNA. Cy5 labeled cDNA was prepared form 10 μg/5 μl Universal Human Reference RNA (UHRR, Statagene) through reverse transcription by SuperScript™ Indirect cDNA Labeling Kit (Invitrogen). Purification process was carried out with MINELute Purification Kit from QIAGEN. cDNA concentration was calculated with UV absorbance at 260 nm by ND-1000 spectrophotometer from NanoDrop Technologies, Inc.

### Example 2.11

cDNA Hybridization/Fluorescence Analysis. After annealing from 95° C., Cy5 labeled cDNA in 3.5×SSC and 0.3% SDS buffer was hybridized with 96 kinds of probe DNAs on the dendron modified glass slides in Agilent hybridization kit for 12 h at 45° C. After the reaction, the substrates were stirred at 37° C. for 30 s and soaked for 1 min in hybridization buffer solution (2×SSPE buffer (pH 7.4) containing 7.0 mM sodium dodecylsulfate) and repeated. The substrate was washed with 0.2×SSC buffer containing 30 mM sodium chloride and 3.0 mM sodium citrate for 1 min to remove nonspecifically bound oligonucleotide. Fluorescence intensity of cDNA was measured by GenePix® Personal 4100A from Molecular Devices.

### Example 3

AFM Force Measurements. All force measurements were performed with a NanoWizard AFM (JPK Instrument). The spring constant of each AFM tip was calibrated in solution before each experiment by the thermal fluctuation method. The spring constants of the cantilevers employed varied between 12 and 15 pN/nm. All measurements were carried out in a fresh PBS buffer (pH 7.4) at room temperature. Force curves were always recorded more than 20 times at one position of 100 pixels in a 10×10 μm region on a substrate, and at least three other regions were examined on the same surface. It should also be noted that the experiment was repeated many times using different tips and samples, and the force data reported were consistently reproduced.

### Example 4

### Results

Genotyping—We examined sensitivity to detect target DNA by measuring the forces between target DNAs hybridized with probe DNAs on the surface and detection DNAs on the AFM-tip through force-based AFM (FIG. 1 (a)). In all experiments, DNA oligonucleotides were covalently attached to silicon substrates or silicon nitride AFM tips using a modification of a dendron-based surface functionalization method that has been described previously (Table 2).

TABLE 2

DNA names and sequences used for genotyping
experiments

| DNA Name | DNA Sequences |
|---|---|
| Probe DNA | 5′-NH₂-TC TCT GCG GGA CCT TGC ATC-3′ |
| | (SEQ ID NO:1) |
| Target DNA | 5′-CTC GTT GGT GCT ACC GAT GCA AGG |
| | TCC CGC AGA GA-3′ |
| | (SEQ ID NO:2) |
| Detection DNA | 5′-GGT AGC ACC AAC GAG-H₂N-3 |
| | (SEQ ID NO:3) |

After 35 mer target DNA was hybridized with 15 mer probe DNA immobilized on the dendron modified substrate, force versus distance measurements were then recorded as 15 mer detection DNA functionalized on the AFM tips and the remaining 15 mer of target DNA not involved in hybridization event surfaces were brought into and out of contact. AFM force experiments were carried out at 100 positions in the 10×10 μm area. Force measurements per one position were carried out 20 times. When 1 aM target DNA was hybridized with probe DNA, the forces between DNAs were observed at two positions where target DNA exists. The probability to measure the specific force (26±0.6 pN by Gaussian fitting in histogram curves) between target DNA and detection DNA is 80% and no force was observed at 20% force-distance curves in one position where DNA was found. (FIG. 1 (b)). Detection of biological samples at such extremely low amounts is a major challenge for clinical diagnosis and detection. The inventive method shows a sensitivity of ≦10³ target molecules detectable without labeling, a level that is better than the 10⁵ number achievable with a high-density microarray system, and approaching the 10³-10⁴ level usually observed for quantitative PCR (qPCR).²²

This system can apply not only to genotyping but also single nucleotide polymorphism (SNP) in target DNA. In previous works, dendron surface showed a high SNP ability to detect single base mutation. In the case of hybridization with target DNAs having single base mutation, the number of target DNAs which exist as duplex on the substrate are smaller than that which hybridize with relatively more complementary target DNAs, such as fully complementary DNAs. Therefore, the probability of observing bound target DNA was decreased in the case of target DNA containing point mutation. This method can distinguish relatively more complementary target DNA from single nucleotide polymorphism.

Gene expression profiling—cDNA has 50 to 250 thymine residues at 5′ end because it was prepared from mRNA through reverse transcription. Therefore, if detection DNA consisting of 30 adenine residues was used it is possible to confirm presence of the cDNA by Bio-AFM measurement (Table 3). In order to confirm the improved detection limit of the method using Bio-AFM, DNA microarray experiment was carried out and probe DNA with high fluorescence intensity was selected. The detection limit of standard fluorescence based microarray experiment was 62 pg/μl. The two spots where cDNA was detected can be found with Bio-AFM experiments when the concentration of cDNA used was 0.62 fg/μl. In other words, the sensitivity of Bio-AFM measurement was increased 105 times as microarray (FIG. 2 (c)).

TABLE 3

DNA names and sequences used at gene
expression profiling experiments

| | |
|---|---|
| DNA Name | DNA Sequences |

| | |
|---|---|
| Probe DNA | 5′-NH₂-CCC CCA GGA TGG ATA TGA GAT |
| | GGG AGA GGT GAG TGG GGG ACC TTC ACT |
| | GAT GTG GGC AGG AGG GGT GGT-3′ |
| | (SEQ ID NO:4) |
| Detection DNA | 5′-AAA AAA AAA AAA AAA AAA AAA AAA |
| | AAA AAA-H₂N-3 |
| | (SEQ ID NO:5) |

If polythymine residue was used as detection DNA, this system can be applied for the direct detection of mRNA without the complicated process of cDNA preparation from mRNA. Because most mRNA has poly adenine residues at the 3′ end, one AFM tip can detect several target mRNAs without changing the sequence of the detection DNA. Namely, Bio-AFM method has similar sensitivity as qPCR and can carry out parallel detection like DNA microarray without any labeling.

A wide window of the lateral spacing realized by the dendron is another significant advantage. Larger spacing than 3 nm, presumably up to 10 nm is contemplated. The larger spacing is effective to immobilize bigger biomolecules with minimum lateral steric hindrance. Therefore, the inventive system applies not only to genotyping or gene expression profiling but also to bio chips for determining DNA-protein, and protein-protein interactions.

### Example 5

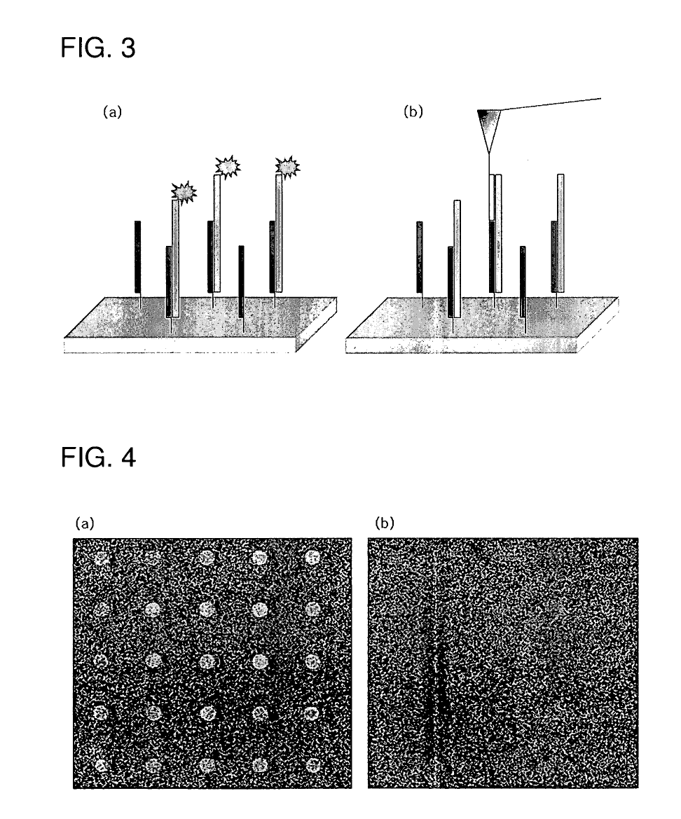

To determine the limitation of a conventional DNA chip assay technique that uses fluorescent labels, we attached a 20-base DNA probe on the chip surface, and hybridized with a 35-base target DNA that contains Cy3 fluorescent labels in the 5′ end as in FIG. 3(a).

As we examined the DNA chip using a fluorescent scanner varying concentrations of the target DNA from the higher to lower level, DNA detection was made as low as 1 μM as shown in FIG. 4.

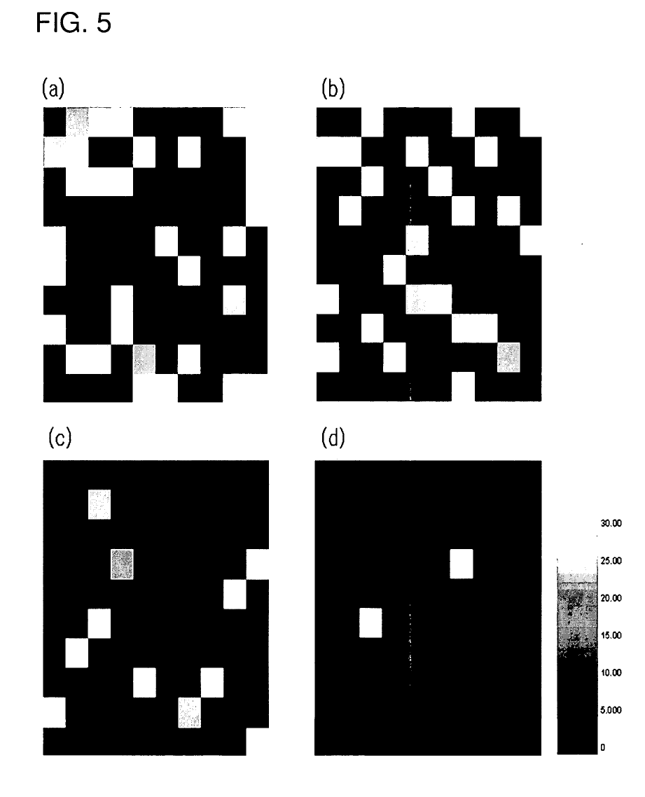

Using a Bio-AFM compared with the fluorescent method we could obtain a force map with a hundred spots in a 10 μm×10 μm area as shown in FIG. 5 by measuring the force between the target and detection DNA. The detection DNA and the target DNA are both adjusted to have GC portion at 60%. We increased the interactive force between the probe and target DNA than the one between the detection and target DNA by having the probe DNA contain 5 more bases than the detection DNA. Since this prevents the target DNA from being attracted to the AFM tip, continuous force measurement is possible.

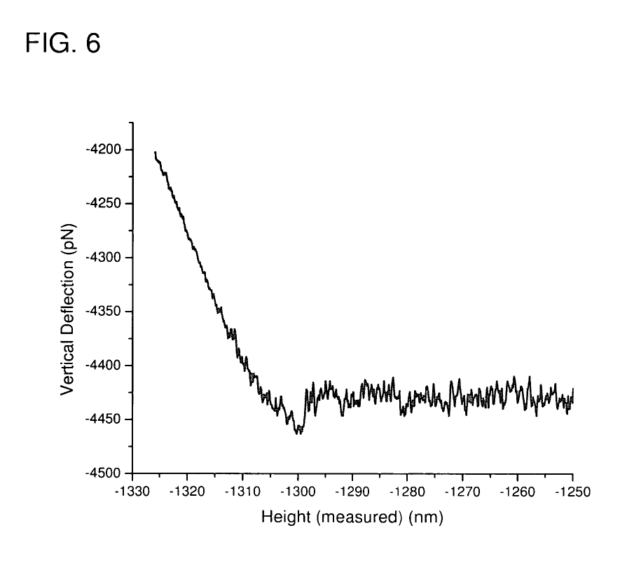

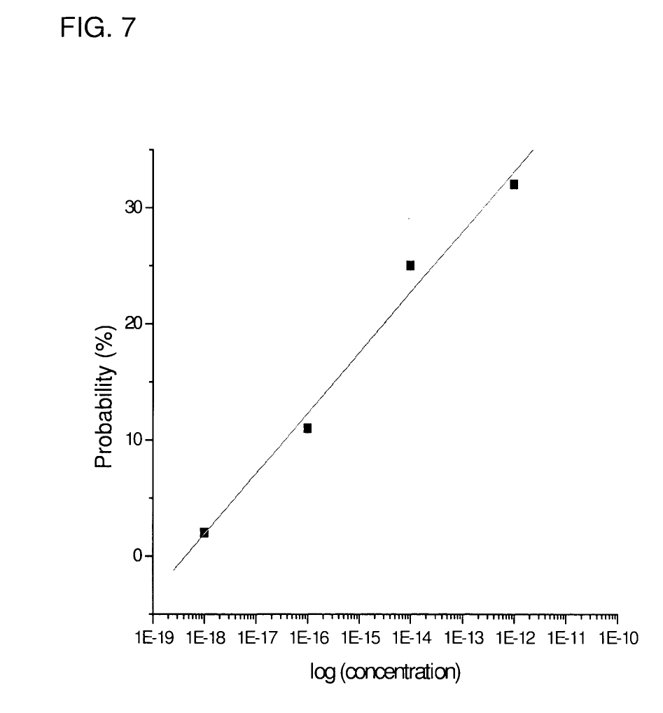

As shown in FIG. 5, the interaction force was not detected where the target DNA is not expected to exist and the 27 pN of the interaction force between the target and detection DNA was measured where the target DNA was hybridized in FIG. 6. In addition, the Bio-AFM method could detect the target DNA as low as 1 aM that is much enhanced than the fluorescent method. One can perform DNA assay without PCR at this concentration level, which is another advantage it has over optical assay such as a fluorescent assay. Furthermore, FIG. 7 shows a linear relationship between the concentration of target DNA and the detection sensitivity.

As stated previously, since amplification by PCR is not required for a Bio-AFM method, whether target DNA exists can be examined by a simple Bio-AFM experiment without prior treatments. In the past, many efforts have been made to decrease the DNA detection limit by using nanoparticles, silver liquid supplements and electrical characteristics. However, they have disadvantages in that they require complicated preprocessing procedures and have low repeatability. Bio-AFM provides repeatable data and does not require prior manipulation of target DNA.

### Example 5.1

### Non-Specific DNA Force Measurement

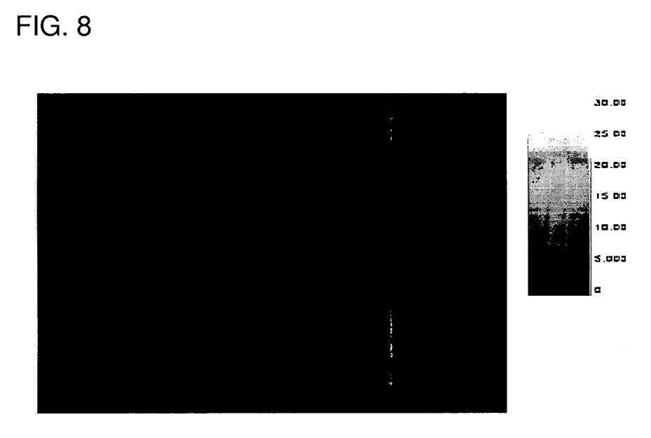

We confirmed that no interaction force between detection and probe DNA is detected where target DNA does not exist. We modified the region of the target DNA that binds with the detection DNA to be non-complementary, and designed the target DNA that binds with the probe DNA to be complementary. In this experiment, we observed that non-specific binding does not occur between target and detection DNAs as shown in FIG. 8.

### Example 5.2

### Single Base Mutation Detection Experiment

The detection capability of Bio-AFM for single base mutation on a DNA chip is determined. From this experiment, one observes the result where single base is different between the probe and target DNA. When there exists single base mutation between the probe and target DNA, the hybridization rate decreases and the force measurement rate between the detection DNA and target DNA decreases likewise.

### Example 5.3

### DNA Chip Assay Using Crosslinking of the Probe DNA and the Target DNA

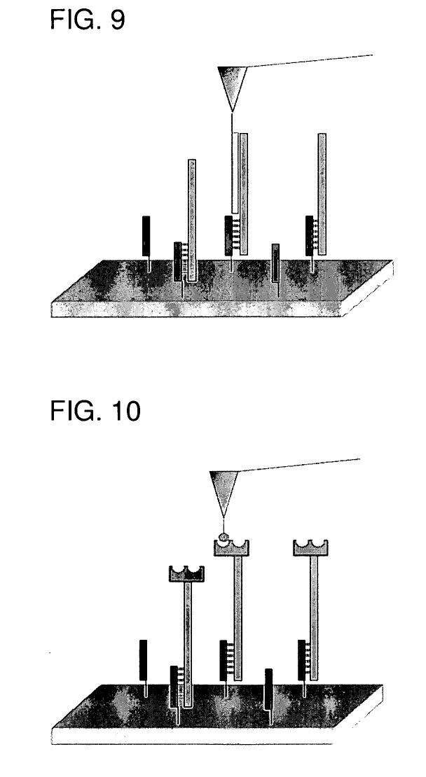

After hybridizing the probe and target DNA, the hybridized DNA is crosslinked using a variety of methods, including but not limited to chemical methods, and the force between the target and detection DNA is measure. Various kinds of target DNA can be detected regardless of the base length of the probe DNA as shown in FIG. 9.

### Example 5.4

### Improving Detection Sensitivity Using Streptavidin-Biotin Binding

After binding the probe and target DNA using the crosslinking method stated earlier, if one forms bonds with streptavidin at the target DNA end, the target DNA can be detected by measuring the bond strength between streptavidin and biotin using the AFM tip that is attached to the biotin. In particular, the hybridization strength between DNA of 15 bases is about 27 pN. It is not much greater than the real noise and hard to distinguish the difference. The bond strength between streptavidin and biotin is greater than 100 pN, thus signal to noise is improved as shown in FIG. 10.

### Example 5.5

### Improvement of Detection Sensitivity Using the Antigen-Antibody Bonds

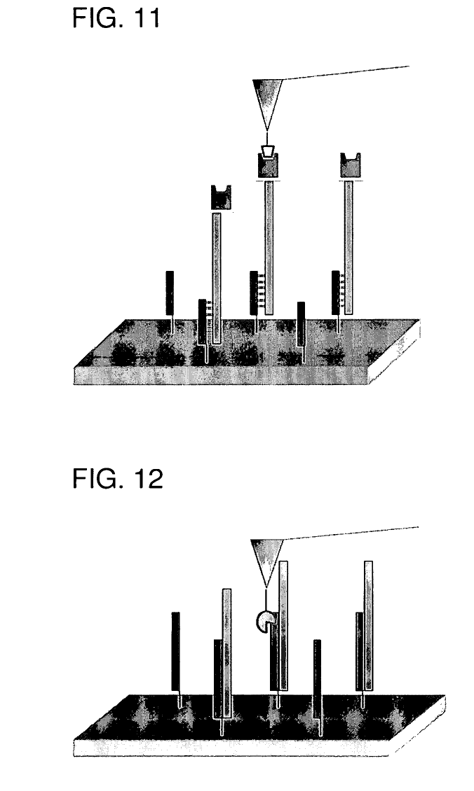

After crosslinking the probe and target DNA, an antigen is bound to the end of the target DNA. By measuring the strength of the antigen-antibody bonds using the AFM tip attached to the antibody, target DNA can be detected as shown in FIG. 11.

### Example 5.6

### DNA Chip Assay of Protein-DNA Bonds

After attaching single-stranded DNA and the protein that can be bound to DNA selectively on the AFM tip surface, a DNA chip assay can be done. The measurement rate of the force between the protein and the single-stranded DNA decreases if target DNA is present in high concentration. Lowering the concentration level of the target DNA to the lower degree, the force measurement rate would increase and then this can be used as a DNA chip assay. It would be within the skill of person of skill in the art to optimize the conditions for detecting protein-DNA bonds.

On the other hand, protein that selectively binds to double-stranded DNA is attached AFM tip surface. DNA chip assay is carried out. If an experiment is performed that measures the force between the protein and the target DNA subsequent to hybridizing in low concentration target DNA, the probability that the double-stranded DNA exists would decrease. By increasing the concentration of the target DNA, the probability of detecting double-stranded DNA increases and the force measurement rate between the protein and the double-stranded DNA also increases (FIG. 12).

### Example 5.7

### DNA Chip Assay for Triplex DNA Formation

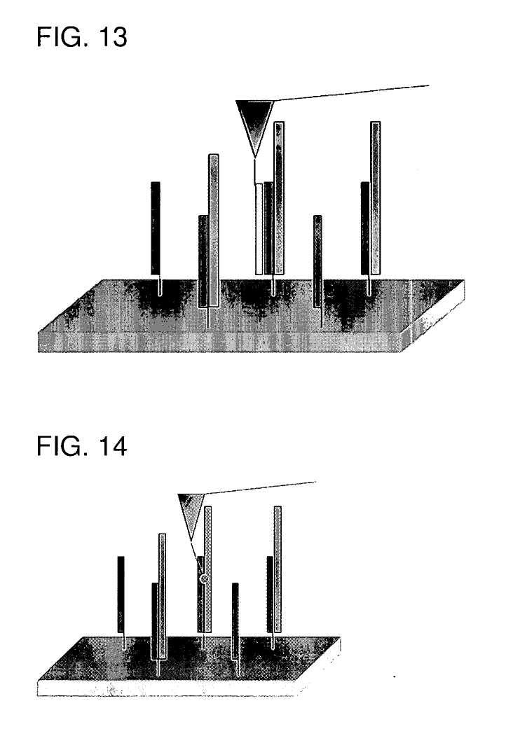

After attaching the detection DNA with a specific base sequence on the AFM tip and adding chemicals or proteins that induce triplex formation, a DNA chip assay is carried out. At a region where target DNA and probe DNA are hybridized, triplex DNA is formed. Bio-AFM can measure the force when the triplex DNA is formed and confirm the existence of the target DNA (FIG. 13).

### Example 5.8

### DNA Chip Assay of Intercalated DNA

Double-stranded nucleic acid intercalators such as EtBr (Ethidium Bromide) are attached to an AFM tip. DNA assay can be carried out by measuring the force at the double-stranded region where the target and probe DNA are hybridized (FIG. 14).

### Example 5.9

### DNA Assay Chip Development for Single Base Mutation Assay Using MutS Protein

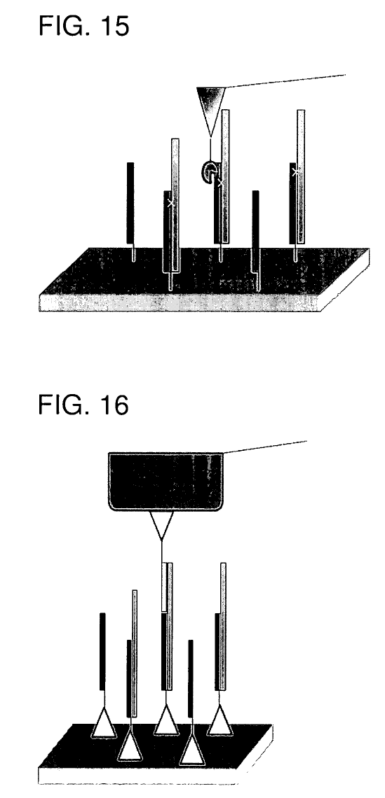

MutS protein selectively binds to double-stranded DNA that has single base mutation rather than fully complementary DNA. DNA assay is carried out by attaching the MutS protein on the AFM tip and measuring the force of binding between the DNA and the protein. No force is measured in the region where the complementary DNA duplex is present. Force is measured in the region that single base mutation exists. DNA chip assay for single base mutation is carried out by measuring the force directly, not as an indirect method in which the detection rate is observed (FIG. 15).

### Example 5.10

### DNA Chip Assay on Dendron Surface Using Force Measurement Between DNA

Dendron solid substrate that has a controlled mesospace is disclosed. The space between the molecular species on the surface is maintained to reduce undesirable steric hindrance and provide an environment to detect interactions among molecular species. The molecular species include without limitation, proteins, antigens, antibodies, signal peptides, membrane proteins, small molecules, steroids, glucose, DNA, RNA and so on. Thus, for example, using the surface of dendron to measure the force between the target and detection DNA by Bio-AFM would improve the performance compared with the environment where the space between the molecular species is not controlled, or mixed self-assembly is used to control the space as it does not incur non-specific binding. In particular, the methods that increase detection sensitivity by streptavidin-biotin or antigen-antibody method involve bigger proteins than DNA, the extended generation of dendron would solve the potential steric hindrance problems.

Methods of preparing dendrons, coating surfaces or substrates with dendrons, and attaching molecular species on the dendron terminals are described in WO 2005/026191 and WO 2006/016787, the contents of which are incorporated by reference herein in their entirety for the methods of making dendrons and their use in coating surfaces or substrates, as well as placing molecular species on the apex of the dendrons. Dip pen or micro contact printing techniques for nano or micro-level probe DNA printing is carried out on a pre-processed glass or silicon surface or substrate. The molecular species is attached, and is made into an array. Then, target DNA is hybridized and using the above-mentioned Bio-AFM, the force between target DNA and detection DNA is measured (FIG. 16). The assay may be carried out by a variety of other modified methods as discussed above, such as streptavidin-biotin using cross-linking or antigen-antibody force measurement.

### Example 5.11

### Gene Expression Research Through Measuring Force Between DNA

In conventional gene expression determination on DNA chips, one makes cDNA by reverse transcribing mRNA extracted from tissues or cells and adding fluorescent dyes and hybridizing on the chips where various kinds of probe DNA are attached. The fluorescent strength of the spots is analyzed. One can monitor the expression level of certain genes. The force measurement by Bio-AFM can be applied in this system to find a new concept of gene expression research. The force-measurement by a Bio-AFM can be the method stated earlier to measure the force between DNA or streptavidin-biotin using crosslinking or force measurement between antigen-antibody.

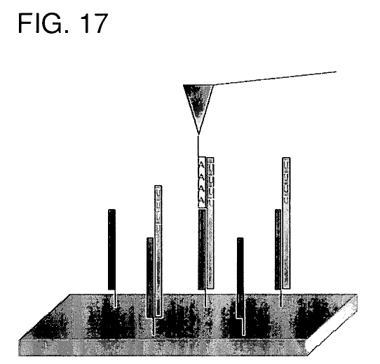

An example of gene expression determination using Bio-AFM force measurement method is as follows. 3′-end of mRNA has 20˜250 poly A so that when a cDNA is made by reverse transcription, it contains complementary poly T. Let the poly T on the cDNA be the binding region for the detection DNA and attach poly A detection DNA sequence on the AFM tip. Force is then measured by A-T hybridization. Thus, by measuring the force of the binding strength between the cDNA and the various probe DNA and determining the detection rate, genes which are more expressed relative to others are discovered (FIG. 17).

In addition, in this gene expression research the amount of cDNA made from the reverse transcription from mRNA is not enough in general for gene expression research as the amount of mRNA extracted from tissues or cells is small for an assay. For this reason, the amount of cDNA is increased by an amplification method such as linear amplification. However, in Bio-AFM experiments the detection limit can be reduced to the attomole level. Therefore, an assay on the difference of mRNA expression level can be carried out using the probe DNA directly without reverse transcription or amplification. As an example, poly T oligonucleotide detection DNA attached to AFM binds directly to mRNA poly A. Force is measured to detect mRNA directly without any additional processing procedures.

### Example 5.12

### DNA Nanoarray Implementation

In conventional DNA microarray systems, the substrate surface, which is spotted with an array of probes comprises an area of about 1 mm². Nanoarray, in contrast, includes an area from about 10 to 100 nm². Such nanoarray is useful in the miniaturization of devices and is applied on point of care products, MEMS and NEMS. DNA array is produced at a nano-level by using either dip-pen technology or micro contact printing technique. Direct target DNA detection is carried out in solution on a substrate surface having an area from about 1 to 10 nm².

### REFERENCES

(1) Fodor, S. P. A. Science 1991, 251, 767-773.
(2) Schena, M.; Shalon, D.; Davis, R. W.; Brown, P. O, Science 1995, 270, 467-470.
(3) Clark, H. A.; Hoyer, M.; Philbert, M. A.; Kopelman, R. Anal. Chem. 1999, 71, 4831-4836.
(4) Dickinson, T. A.; Michael, K. L.; Kauer, J. S.; Walt, D. R. Anal. Chem. 1999, 71, 2192-2198.
(5) Harrison, D. J. Science 1993, 261, 895-897.
(6) Ramsey, J. M.; Jacobson, S. C.; Knapp, M. R. Nat. Med. 1995, 1, 1093-1096.
(7) Woolley, A. T.; Mathies, R. A. Proc. Natl. Acad. Sci. USA 1994, 91, 11348-11352.
(8) Christof M. Niemeyer, D. B. Angewandte Chemie International Edition 1999, 38, 2865-2869.
(9) Gerion, D.; Chen, F.; Kannan, B.; Fu, A.; Parak, W. J.; Chen, D. J.; Majumdar, A.; Alivisatos, A. P. Anal. Chem. 2003, 75, 4766-4772.
(10) Allen, S. R.-S., S. M.; Harris, H.; Davies, M. C.; O'Shea, P. Biochemical Society Transactions 2003, 31, 1052-1057.
(11) Clausen-Schaumann, H.; Seitz, M.; Krautbauer, R.; Gaub, H. E. Current Opinion in Chemical Biology 2000, 4, 524-530.
(12) Kellermayer, M. S.; Smith, S. B.; Granzier, H. L.; Bustamante, C. Science 1997, 276, 1112-1116.
(13) Hummer, G.; Szabo, A. Acc. Chem. Res. 2005, 38, 504-513.
(14) Bayas, M. V.; Leung, A.; Evans, E.; Leckband, D. Biophys. J. 2006, 90, 1385-1395.
(15) Evans, E.; Leung, A.; Heinrich, V.; Zhu, C. Proceedings of the National Academy of Sciences 2004, 101, 11281-11286.
(16) Benoit, M.; Gabriel, D.; Gerisch, G.; Gaub, H. E. Nat Cell Biol 2000, 2, 313-317.
(17) Jung, Y. J.; Hong, B. J.; Zhang, W.; Tendler, S. J. B.; Williams, P. M.; Allen, S.; Park, J. W. J. Am. Chem. Soc. 2007, 129, 9349-9355.
(18) Hong, B. J.; Oh, S. J.; Youn, T. O.; Kwon, S. H.; Park, J. W. Langmuir 2005, 21, 4257-4261.
(19) Schweitzer, B.; Kingsmore, S. Current Opinion in Biotechnology 2001, 12, 21-27.
(20) Zhao, X.; Tapec-Dytioco, R.; Tan, W. J. Am. Chem. Soc. 2003, 125, 11474-11475.
(21) Nygaard, V.; Holden, M.; Loland, A.; Langaas, M.; Myklebost, O.; Hovig, E. BMC Genomics 2005, 6.
(22) Eastman, P. S.; Ruan, W.; Doctolero, M.; Nuttall, R.; deFeo, G.; Park, J. S.; Chu, J. S. F.; Cooke, P.; Gray, J. W.; Li, S.; Chen, F. F. Nano Lett. 2006, 6, 1059-1064.

All of the references cited herein are incorporated by reference in their entirety.

Those skilled in the art will recognize, or be able to ascertain using no more than routine experimentation, many equivalents to the specific embodiments of the invention specifically described herein. Such equivalents are intended to be encompassed in the scope of the claims.

What is claimed is:

1. A method for detecting a presence of target ligand in a fluid medium comprising:
(i) contacting the fluid medium with a solid substrate, wherein the solid substrate comprises:
array of dendrons on its surface, wherein each of said dendron comprises:
a central atom;
a probe that is attached to the central atom optionally through a linker; and
a base portion attached to the central atom and having a plurality of termini that are attached to the surface of the solid support; and
(ii) determining the presence of a probe-target ligand complex by measuring binding force between the bound ligand and detection molecule that has affinity for the ligand, wherein the detection molecule is tethered to surface of a tip of an atomic force microscope (“AFM”), wherein measurement of an increase in force between the probe-target ligand complex and the detection molecule indicates the presence of the probe-target ligand complex.

2. The method of claim 1, wherein the probe-target ligand complex is an oligonucleotide-complementary nucleic acid complex.

3. The method of claim 1, wherein the probe-target ligand complex is detected in the presence of low concentration of the target ligand, which is at a concentration of at least about 1 aM.

4. The method of claim 3, wherein the target ligand is at a concentration of between about 1 aM to about 1000 aM.

5. The method of claim 2, wherein said method is capable of discriminating a single nucleotide polymorphism in the oligonucleotide-complementary nucleic acid complex.

6. The method of claim 1, wherein the detection molecule is detection nucleic acid.

7. The method of claim 1, wherein the detection molecule is comprised of a poly-dT oligomer sufficiently complementary to a poly-dA section of RNA.

8. The method of claim 1, wherein the solid substrate is a non-porous solid support.

9. The method of claim 8, wherein the solid substrate is a planar non-porous solid support.

10. The method of claim 1, wherein the solid substrate is a biochip.

11. The method of claim 1, wherein the tip of the atomic force microscope (“AFM”) is coated with dendron.

12. The method of claim 1, wherein the target ligand is not labeled.

13. The method of claim 1, comprising further cross-linking the probe-ligand complex.

14. The method of claim 1, wherein the probe-ligand complex is covalently linked to an affinity molecule, and detection molecule specifically binds to the affinity molecule.

15. The method of claim 14, wherein the affinity molecule is an antigen or an antibody.

16. The method of claim 1, wherein the detection molecule is a protein that selectively binds to double stranded DNA.

17. The method of claim 1, wherein the probe-ligand complex forms a triple helix formation with the detection molecule.

18. The method of claim 1, wherein the detection molecule is a DNA intercalating agent.

19. The method of claim 1, wherein the detection molecule is a protein, which selectively binds to a mismatched section of a double stranded DNA.

20. A system for detection of target nucleic acid, comprising, (i) a biochip immobilized with probe molecules, and (ii) an atomic force microscope (“AFM”) comprising a tip on which is tethered detection molecule.

21. The system according to claim 20, wherein the biochip is coated with dendrons on which are tethered probe molecules.

22. The system according to claim 21, wherein the tip of the AFM is coated with dendrons, on which are immobilized detection molecules.


SEQUENCE LISTING (5 sequences)

SEQ ID NO: 1 - DNA, 20 bp, Artificial Sequence
  Probe DNA
tctctgcgggaccttgcatc

SEQ ID NO: 2 - DNA, 35 bp, Artificial Sequence
  Target DNA
ctcgttggtgctaccgatgcaaggtcccgcagaga

SEQ ID NO: 3 - DNA, 15 bp, Artificial Sequence
  Detection DNA
ggtagcaccaacgag

SEQ ID NO: 4 - DNA, 69 bp, Artificial Sequence
  Probe DNA
cccccaggatggatatgagatgggagaggtgagtgggggaccttcactgatgtgggcaggaggggtggt

SEQ ID NO: 5 - DNA, 30 bp, Artificial Sequence
  Detection DNA
aaaaaaaaaaaaaaaaaaaaaaaaaaaaaa